(19) United States
(12) Patent Application Publication
(10) Pub. No.: US 2026/0147888 A1
(43) Pub. Date: May 28, 2026

(54) SYSTEMS AND METHODS FOR DETECTING SCALABLE MALWARE SIMILARITY VIA DATASTORE OF ASSEMBLY-LEVEL MALICIOUS BEHAVIOR IMPLEMENTATIONS EXTRACTED FROM MEMORY

(71) Applicant: Georgia Tech Research Corporation, Atlanta, GA (US)

(72) Inventors: Kevin Valakuzhy, Atlanta, GA (US); Newman Fabian Monrose, Atlanta, GA (US)

(21) Appl. No.: 19/380,650

(22) Filed: Nov. 5, 2025

Related U.S. Application Data
(60) Provisional application No. 63/716,574, filed on Nov. 5, 2024.

(51) Int. Cl. G06F 21/56

(52) U.S. Cl. CPC G06F 21/561; G06F 21/563

(57) ABSTRACT

The present disclosure provides a computer-implemented method for identifying malware family relationships, comprising capturing a plurality of memory snapshots of a malicious executable during dynamic execution, wherein each memory snapshot is triggered by detection of a behavioral anchor corresponding to a malicious behavior. The method includes extracting assembly-level code implementations from the memory snapshots using targeted disassembly, wherein each assembly-level code implementation represents a gene corresponding to an implementation of the malicious behavior. The method further comprises comparing the genes extracted from a first malware sample with genes stored in a gene datastore to identify similar genes, and determining a malware family relationship between the first malware sample and a second malware sample based on shared genes that exhibit identical assembly-level implementations of the same malicious behavior.

### CROSS-REFERENCE TO RELATED APPLICATIONS

This application claims priority to U.S. Provisional Application No. 63/716,574, titled SYSTEMS AND METHODS FOR DETECTING SCALABLE MALWARE SIMILARITY VIA DATASTORE OF ASSEMBLY-LEVEL MALICIOUS BEHAVIOR IMPLEMENTATIONS EXTRACTED FROM MEMORY, filed Nov. 5, 2024, which is hereby incorporated by reference in its entirety.

### FIELD OF INVENTION

The present disclosure relates to cybersecurity and malware analysis systems, and more particularly to systems and methods for detecting scalable malware similarity via a datastore of assembly-level malicious behavior implementations extracted from memory snapshots during dynamic execution.

### BACKGROUND

Malicious software, commonly referred to as malware, poses a persistent and evolving threat to computer systems and networks worldwide. As the volume and sophistication of malware continue to increase, cybersecurity professionals face mounting challenges in analyzing and categorizing these threats in a timely manner. The rapid proliferation of malware variants has created a substantial burden on security analysts, who must manually examine thousands of samples daily to understand their capabilities and relationships.

Traditional approaches to malware analysis rely heavily on static analysis techniques, which examine the binary code of malware samples without executing them. However, modern malware frequently employs obfuscation techniques such as packing, encryption, and polymorphism to conceal its malicious functionality from static analysis tools. These obfuscation methods can render static analysis ineffective, as the true malicious code remains hidden until the malware executes in memory.

Dynamic analysis techniques address some limitations of static analysis by executing malware samples in controlled environments and observing their runtime behavior. While dynamic analysis can reveal the true functionality of obfuscated malware, existing approaches often generate large volumes of data that require substantial processing time and computational resources. The time-sensitive nature of malware analysis workflows makes processing delays particularly problematic for security operations centers that must rapidly triage and respond to emerging threats.

Malware family classification represents another challenge in the field of cybersecurity. Security analysts group related malware samples into families based on shared characteristics, allowing them to apply similar mitigation strategies and leverage prior analysis work. However, distinguishing between malware families can be difficult when samples share common behaviors or utilize similar application programming interfaces to achieve their malicious objectives. Additionally, malware authors may deliberately reuse code components across different families, creating false connections that can mislead classification efforts.

Binary code similarity analysis has emerged as a technique for identifying relationships between malware samples by comparing their assembly-level implementations. While these approaches can identify code reuse patterns, they face scalability challenges when applied to large datasets containing millions of functions. The computational overhead associated with pairwise function comparisons can make real-time analysis impractical for operational environments.

Table 1 may present a comparative analysis of existing binary code similarity approaches for malware family classification, demonstrating the limitations of current techniques when applied to large-scale malware analysis. The table may include columns for approach name, performance considerations for code extraction and similarity computation, family-based analysis capabilities, and evaluation dataset size. In some cases, Table 1 may reveal that existing approaches either fail to consider performance factors for code extraction and similarity analysis, have limited capabilities for family-based malware classification, or were evaluated on substantially smaller datasets compared to the comprehensive evaluation performed on the disclosed invention.

TABLE 1
Approaches that use binary code to find relationships between malware. “# Families
in Eval” is w.r.t family clustering with ⊥ indicating no such evaluation was performed.

| Ref. | | | | | | | Family Based Analysis | | |
|---|---|---|---|---|---|---|---|---|---|
| | | APIs/ | Inputs | | Perf. Consider. | | Cross- | Rectifies | |
| | Binary | System | Debug | Dynamic | Code | Code | Family | Family | # Familied |
| | Code | Calls | Symbols | Analysis | Extraction | Similarity | Relations | Labels | in Eval |
| [47] | ✓ | ✓ | | ✓ | | | | | ⊥ |
| [43] | ✓ | ✓ | | ✓ | | ✓ | | | ⊥ |
| [48] | ✓ | ✓ | | ✓ | | ✓ | | ✓ | 4 |
| [23] | ✓ | | ✓ | | | ✓ | | | 90 |
| Ours | ✓ | ✓ | | ✓ | ✓ | ✓ | ✓ | ✓ | 272 |

The comparative analysis shown in Table 1 may demonstrate that previous binary code similarity approaches were typically evaluated on datasets containing fewer than 50 malware families, while the disclosed approach was tested on 272 distinct malware families, representing a significant advancement in evaluation scope and real-world applicability. The table may show that existing techniques often overlook the computational overhead associated with code extraction and similarity computation, making them impractical for operational environments that require rapid analysis of large malware datasets. In some cases, Table 1 may illustrate that prior approaches lack the family-based analysis capabilities necessary for accurate malware classification, highlighting the need for the behavioral anchor-based gene extraction and temporal relationship analysis techniques disclosed herein.

The temporal aspects of malware execution also present analytical challenges. Multi-stage malware samples may exhibit different behaviors at various points during their execution lifecycle, with some functionality remaining dormant until specific conditions are met. Understanding these temporal relationships can provide insights into malware evolution and code sharing patterns, but existing analysis techniques often treat all observed behaviors as equally relevant regardless of when they appear during execution.

Human expertise remains indispensable for in-depth malware analysis, particularly for novel and sophisticated threats. However, the growing gap between the volume of malware samples requiring analysis and the availability of skilled analysts has created bottlenecks in security operations. Tools and techniques that can augment human analysts by providing rapid initial assessments and identifying relationships between samples can help address these resource constraints.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computer-implemented method for identifying malware family relationships is provided. The method comprises capturing a plurality of memory snapshots of a malicious executable during dynamic execution, wherein each memory snapshot is triggered by detection of a behavioral anchor corresponding to a malicious behavior. The method includes extracting assembly-level code implementations from the memory snapshots using targeted disassembly, wherein each assembly-level code implementation represents a gene corresponding to an implementation of the malicious behavior. The method further comprises comparing the genes extracted from a first malware sample with genes stored in a gene datastore to identify similar genes. The method also includes determining a malware family relationship between the first malware sample and a second malware sample based on shared genes that exhibit similar malicious behavior, wherein the similar malicious behavior is determined using binary code similarity metrics.

According to other aspects of the present disclosure, the computer-implemented method may include one or more of the following features. The behavioral anchor may comprise an application programming interface (API) call associated with the malicious behavior. The API call may be selected from the group consisting of CreateProcessA, WaitForSingleObject, and RegSetValueEx. The targeted disassembly may comprise starting disassembly at an address of the behavioral anchor, applying recursive descent disassembly to identify instructions following the behavioral anchor, identifying a closest API call site prior to the behavioral anchor, and disassembling code between the closest API call site and the behavioral anchor. The targeted disassembly may further comprise applying linear sweep disassembly to identify adjacent functions when recursive descent disassembly fails to cross function boundaries. Capturing the plurality of memory snapshots may comprise using a plurality of snapshot triggers, each snapshot trigger configured to capture memory regions when predetermined conditions are met. The predetermined conditions may comprise a memory region being made executable for a first time, detection of network behavior within code contained in a memory region, and termination of a process associated with the malicious executable. The method may further comprise analyzing temporal relationships between the memory snapshots to distinguish between homologous genes and analogous genes. The homologous genes may comprise genes shared by malware samples from the same family due to common ancestry, and analogous genes may comprise genes exhibiting the same behavior but originating from different malware families. Analyzing temporal relationships may comprise identifying stage transitions in multi-stage malware execution by detecting abandoned genes between consecutive memory snapshots.

According to another aspect of the present disclosure, a malware analysis system is provided. The system comprises a memory extraction engine configured to capture memory snapshots of malicious executables during dynamic execution based on behavioral anchor triggers. The system includes a gene extraction module configured to extract assembly-level behavioral implementations from the memory snapshots using targeted disassembly. The system further comprises a gene datastore configured to store the extracted assembly-level behavioral implementations. The system also includes a gene matching module configured to compare genes between malware samples and identify malware family relationships based on shared assembly-level implementations of malicious behaviors.

According to other aspects of the present disclosure, the malware analysis system may include one or more of the following features. The behavioral anchor triggers may comprise detection of application programming interface calls associated with malicious behaviors. The application programming interface calls may be selected from the group consisting of CreateProcessA, WaitForSingleObject, RegSetValueEx, and VirtualAlloc. The targeted disassembly may comprise starting disassembly at an address of a behavioral anchor, applying recursive descent disassembly to identify instructions following the behavioral anchor, identifying a closest API call site prior to the behavioral anchor, and disassembling code between the closest API call site and the behavioral anchor. The system may further comprise a temporal analysis module configured to analyze temporal relationships between memory snapshots to distinguish between homologous genes shared by malware samples from the same family and analogous genes exhibiting the same behavior but originating from different malware families.

According to another aspect of the present disclosure, a computer-implemented method for detecting cross-family code sharing in malware is provided. The method comprises capturing temporal memory snapshots of a malicious executable across multiple execution stages. The method includes extracting genes representing assembly-level implementations of malicious behaviors from each temporal memory snapshot. The method further comprises analyzing temporal relationships between the genes across the execution stages to identify gene abandonment patterns. The method also includes classifying cross-family code sharing relationships based on the temporal relationships, wherein genes appearing in different execution stages indicate dropper-payload relationships between different malware families.

According to other aspects of the present disclosure, the computer-implemented method for detecting cross-family code sharing may include one or more of the following features. Analyzing temporal relationships may comprise identifying a stage transition when genes present in a first execution stage are abandoned in a subsequent execution stage. Classifying cross-family code sharing relationships may comprise determining that genes appearing in the subsequent execution stage match genes from a different malware family than genes appearing in the first execution stage. The genes appearing in different execution stages may comprise genes associated with obfuscation tools that appear in initial execution stages. The obfuscation tools may comprise Nullsoft Scriptable Install System (NSIS) installers used to deter malware analysis.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a malware analysis system configured to detect scalable malware similarity, according to aspects of the present disclosure.

FIG. 2A presents a histogram illustrating distribution of similarity scores using normalized Levenshtein edit distance for malware samples, according to aspects of the present disclosure.

FIG. 2B presents a histogram displaying distribution of similarity scores using Graph Matching Networks for malware sample pairs, according to aspects of the present disclosure.

FIG. 2C presents a histogram displaying distribution of similarity scores using Graph Matching Networks with raw score values, according to aspects of the present disclosure.

FIG. 3 depicts a graph illustrating relationships between recall and Matthews Correlation Coefficient for malware similarity approaches, according to aspects of the present disclosure.

FIG. 4 illustrates a malware similarity network depicting relationships between malware samples and behavioral implementations, according to aspects of the present disclosure.

FIG. 5 illustrates a sequence diagram depicting temporal analysis for identifying cross-family code sharing relationships, according to aspects of the present disclosure.

FIG. 6 illustrates a system diagram depicting temporal relationships between genes across multi-stage malware execution, according to aspects of the present disclosure.

FIG. 7 illustrates a flowchart for a method for capturing and analyzing temporal behavioral patterns in malware execution, according to aspects of the present disclosure.

FIG. 8 illustrates a flowchart for a method for classifying genes and recording temporal relationships between malware families, according to aspects of the present disclosure.

FIG. 9 illustrates a flowchart for a method for analyzing temporal gene patterns and classifying malware execution stages, according to aspects of the present disclosure.

FIG. 10 illustrates a block diagram of a computing system architecture that may be used to implement the malware analysis system, according to aspects of the present disclosure.

FIG. 11 illustrates a network architecture diagram depicting a distributed computing environment that may be used to implement the malware analysis system, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

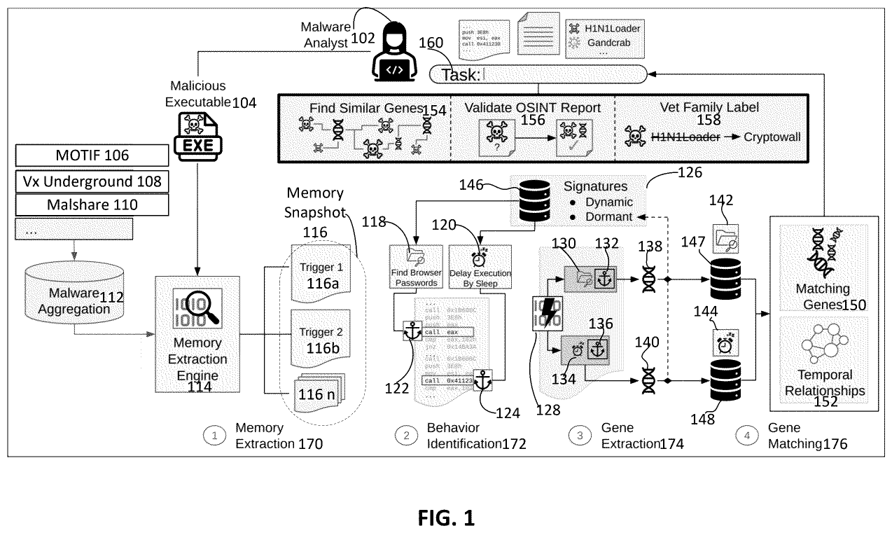

Referring to FIG. 1, a malware analysis system 100 may be configured to detect scalable malware similarity via a datastore of assembly-level malicious behavior implementations extracted from memory. The malware analysis system 100 may receive input from a malware analyst 102 and may process a malicious executable 104 obtained from various sources. The malicious executable 104 may be sourced from MOTIF 106, VX Underground 108, and Malshare 110, which may feed into a malware aggregation 112 component that consolidates malware samples for analysis.

The malware analysis system 100 may be evaluated using a comprehensive dataset that demonstrates the scale and scope of the disclosed approach. Table 3 may present dataset statistics that provide foundational metrics for the malware similarity detection system. The dataset may comprise 1,772 malware samples spanning 272 distinct malware families, demonstrating the diversity of malicious software analyzed through the disclosed techniques. In some cases, the dataset may include 158,694 memory snapshots captured during dynamic execution, illustrating the substantial volume of temporal behavioral data processed by the memory extraction engine 114.

TABLE 3
Dataset Statistics

| | |
|---|---|
| Malware Samples | 1,772 |
| Malware Families | 272 |
| Trigger-based Memory Snapshots | 158,694 |
| Unique Functions | 3,054,138 |
| Behaviors | 119 |
| Unique Genes | 4,623 |

The dataset statistics shown in Table 3 may reveal the comprehensive nature of the evaluation performed on the malware analysis system 100. The 272 malware families may represent a broad spectrum of malicious software categories, enabling thorough assessment of the gene extraction 174 and gene matching 176 phases across diverse behavioral implementations. In some aspects, the large number of memory snapshots may demonstrate the temporal richness of the dataset, where each snapshot may contain multiple behavioral anchors corresponding to malicious behaviors that are processed through the behavior identification 172 phase.

Table 3 may also include additional metrics that characterize the dataset's complexity and analytical scope. The statistics may encompass the total number of genes extracted through the targeted disassembly approach, the distribution of behavioral implementations across different malware families, and the temporal coverage achieved through the plurality of snapshot triggers. In some cases, the dataset metrics may provide evidence for the scalability of the disclosed approach, demonstrating that the malware analysis system 100 can process large volumes of malware samples while maintaining the performance improvements achieved through the behavior anchor 132 component and the found browser password gene 138 analysis techniques.

The malware analysis system 100 may comprise four primary processing phases: memory extraction 170, behavior identification 172, gene extraction 174, and gene matching 176. A memory extraction engine 114 may be configured to capture memory snapshots of malicious executables during dynamic execution based on behavioral anchor triggers. The memory extraction engine 114 may be implemented using commercial VMRay Analyzer configured to use 64-bit Windows 7 virtual machines for dynamic analysis of malicious executables. In some cases, the memory extraction engine 114 may operate with a configurable execution timeout of 180 seconds based on analysis showing 99% of behaviors are found within the first three minutes.

The memory extraction engine 114 may capture a plurality of memory snapshots 116 during malware execution, where each memory snapshot may be triggered by detection of a behavioral anchor corresponding to a malicious behavior. The memory extraction engine 114 may operate based on multiple trigger conditions, including Trigger 1 116a, Trigger 2 116b, and Trigger n 116n, which may determine when memory regions are captured during dynamic analysis. The plurality of memory snapshots 116 may be captured using a plurality of snapshot triggers, where each snapshot trigger may be configured to capture memory regions when predetermined conditions are met.

With continued reference to FIG. 1, the memory snapshots 116 may be captured using eight different trigger types including first network behavior, change in tracked content, execution of file of interest, end of analysis time, first execution in writeable memory region, buffer marked executable, process termination, and found file image in buffer. The predetermined conditions may comprise a memory region being made executable for a first time, detection of network behavior within code contained in a memory region, and termination of a process associated with the malicious executable 104.

The behavior identification 172 phase may include a found browser passwords behavior 118 component that identifies malicious behaviors such as delay execution by sleep behavior 120. A behavior anchor 122 may be used to locate specific implementations of behaviors within the captured memory snapshots 116. The behavioral anchor triggers may comprise detection of application programming interface calls associated with malicious behaviors. The behavioral anchors may include specific API calls such as CreateProcessA, WaitForSingleObject, RegSetValueEx, VirtualAlloc, and system calls like RDTSC or CPUID instructions.

The behavior identification 172 phase may include behavioral signatures such as found browser passwords behavior 118 and delay execution by sleep behavior 120 that identify specific malicious behaviors. These behavioral signatures may be used to locate API call sites that serve as behavioral anchors, represented by behavior anchor 122 and behavior anchor 124 within the captured memory snapshots 116. The behavioral anchor triggers may comprise detection of application programming interface calls associated with malicious behaviors. The behavioral anchors may include specific API calls such as CreateProcessA, WaitForSingleObject, RegSetValueEx, VirtualAlloc, and system calls like RDTSC or CPUID instructions.

A behavior anchor 124 process may employ signatures 126 that enable detection of both actively executing and dormant behavioral implementations through targeted disassembler 128. The targeted disassembler 128 may extract assembly-level code from functions containing the behavioral anchors, with the extracted code represented by found browser password 130 and delayed execution by sleep 134, which serve as genes corresponding to implementations of the identified malicious behaviors.

In an alternative embodiment, a behavior anchor 124 process may employ signatures 126 that identify behaviors categorized as delay execution by sleep 120 and found browser password 118, enabling detection of both actively executing and dormant behavioral implementations. Targeted disassembly 128 is used to efficiently extract assembly-level code corresponding to identified behaviors. In some cases, this alternative approach may provide streamlined behavioral identification by directly categorizing behaviors through the signature matching process before proceeding to assembly-level code extraction.

The gene extraction 174 phase may employ performance optimization techniques that demonstrate substantial improvements over traditional disassembly approaches. Table 2 may present comparative performance metrics showing the efficiency gains achieved through the targeted disassembly approach implemented by the targeted disassembler 128. The table may include measurements of disassembly time, memory snapshot processing duration, and data volume reduction achieved through the targeted disassembly methodology.

TABLE 2
Avg. time and data disassembled using different approaches to
reducing memory and snapshots, computed over 100 samples.

| Approach | Data Size (KB) | Time (s) |
|---|---|---|
| All trigger-based snapshots | 22,200 | 843 |
| Only saving the final snapshot per memory | 8,900 | 341 |
| region | | |
| Same as above, but only saving the | 3,100 | 85 |
| corresponding snapshots with genes | | |
| Same as above, but using Targeted | 66 | 1 |
| Disassembly | | |

In some cases, Table 2 may demonstrate that the targeted disassembly technique reduces disassembly time by over 300× compared to conventional full memory disassembly approaches, achieving average processing times of just under one second per memory snapshot. The performance improvements may result from focusing analysis solely on genes rather than disassembling entire memory snapshots captured by the memory extraction engine 114. The table may show that traditional approaches requiring comprehensive disassembly of all memory regions may consume several minutes per snapshot, while the targeted approach processes only the memory regions suspected of containing behavioral implementations. Table 2 may also illustrate data volume reduction metrics, showing that the targeted disassembly approach reduces average memory snapshot size from approximately 22 MB to 66 KB. This substantial reduction may be achieved by the targeted disassembly 128 process, which skips extracted memory regions that do not contain behavioral anchors, thereby avoiding disassembly of memory that yields no practical benefit for malware family classification. In some aspects, element 134 may represent an icon depicting the behavior that anchor 136 is associated with, where the anchor in 136 indicates that the code collected contains a behavioral anchor. Table 2 may demonstrate that filtering genes further contributes to processing efficiency by eliminating wrapper functions that lack sufficient discriminatory power.

The performance metrics presented in Table 2 may support the scalability of the malware analysis system 100 for operational environments where time-sensitive analysis workflows require rapid processing of large volumes of malware samples. The targeted disassembly and gene filtering enables the efficient collection of genes. Two examples of those genes are a ‘found browser password gene’ 138 and ‘delayed execution by sleep gene’ 140. The table may show that the combination of targeted disassembly and gene filtering enables efficient gene comparisons across multiple gene datastore instances while maintaining the accuracy needed for reliable malware family classification. The system also improves efficiency in the gene matching stage 176 over a full pairwise comparison by comparing only genes that exhibit the same behavior.

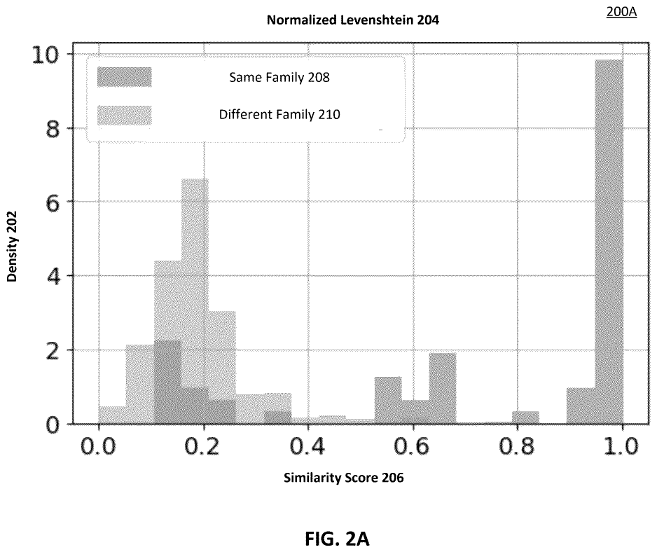

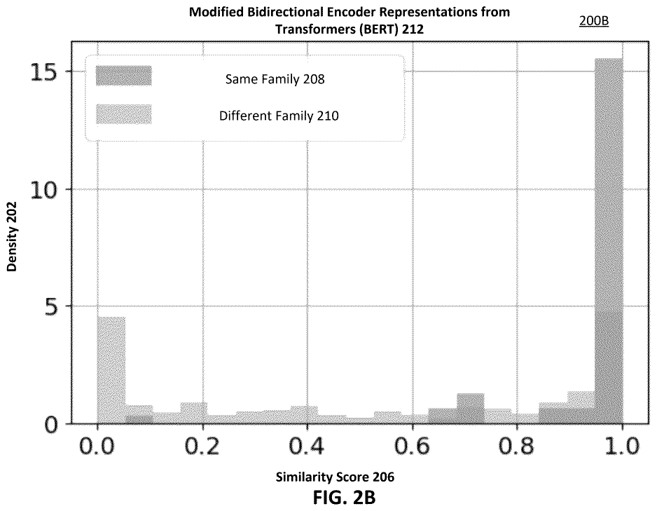

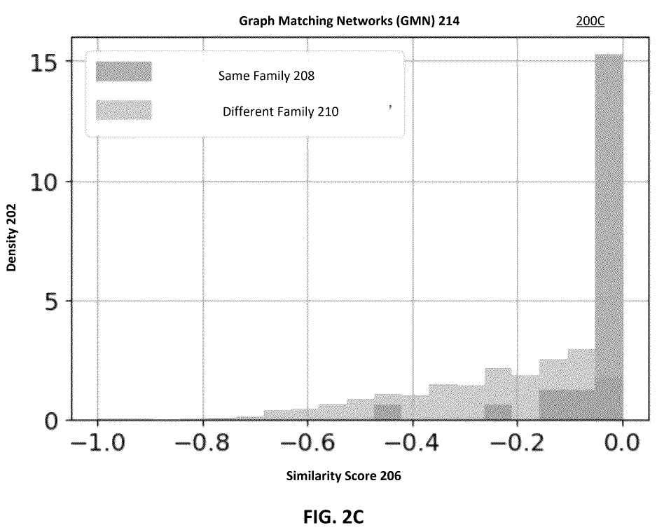

As further shown in FIG. 1, the gene extraction 174 phase may use signatures created by matching instruction opcodes with wildcards for operands, focusing only on opcodes as a form of normalization to enable matching of dormant genes after changes to constant values or memory relocation. Elements 138 and 140 are examples of genes, which are pieces of data that go into behavior-specific datastores represented by gene datastore 146 and gene datastore 148. Comparisons are performed using one of the binary code similarity approaches, as discussed in FIGS. 2A, 2B, and 2C. The gene extraction module may use Python interface for Microsoft's Hyperscan regular expression library for scanning dormant behaviors, providing 10× faster matching speeds than YARA.

The gene matching phase 176 may identify matching genes 150 stored in multiple gene datastore instances, including gene datastore 147 and gene datastore 148. Behavioral elements 142 and 144 are icons that depict the behavior that each datastore is associated with. For example, gene datastore 147 (under behavioral element 142) is a datastore containing the genes associated with the “Find Browser Passwords” behavior, which is first shown in element 118. Gene datastore 146 (next to signatures 126) is a datastore of signatures, where dormant signatures are built from genes that were identified by the system. Examples of these genes include found browser password gene 138 and delayed execution by sleep gene 140, which are data used in the matching process and placed into the behavior-specific datastores to build dormant signatures. Temporal analysis is performed in temporal relationships 152 between gene appearances across memory snapshots 116. The malware analysis system 100 may provide output to a find similar genes 154 component that supports various analytical tasks, including validate OSINT report 156 and vet family label 158, which may be presented to the malware analyst 102 through a task 160 interface.

With continued reference to FIG. 1, the gene extraction 174 phase may employ a targeted disassembly technique to extract assembly-level code implementations from the memory snapshots 116. The targeted disassembly may be implemented using Python on top of a Capstone disassembly engine for processing assembly instructions. The Capstone disassembly engine may provide a common foundation for implementing disassembly routines and may enable efficient extraction of assembly-level behavioral implementations from captured memory regions.

The targeted disassembly process may start disassembly at an address of a behavioral anchor identified during the behavior identification 172 phase. The behavioral anchor may provide a known starting point for an instruction in a gene that is being disassembled. The targeted disassembly may apply recursive descent disassembly to identify instructions following the behavioral anchor. The recursive descent disassembly may operate by following control flow to find instructions within the same gene that come after the behavioral anchor.

As further shown in FIG. 1, the targeted disassembly may identify a closest API call site prior to the behavioral anchor to reach instructions before the behavioral anchor. The targeted disassembly may disassemble code between the closest API call site and the behavioral anchor. In some cases, the targeted disassembly may use API call sites progressively further from the behavioral anchor as starting points until a configurable threshold number of instructions is disassembled.

The targeted disassembly may further apply linear sweep disassembly to identify adjacent functions when recursive descent disassembly fails to cross function boundaries. The linear sweep approach may assume instructions are laid out successively and may be applied once recursive descent has completed. In some cases, the linear sweep disassembly may identify adjacent functions when the starting point belongs to a separate function from the target gene.

The gene extraction 174 phase may include a filter genes component that removes genes with fewer than five instructions to exclude wrapper functions that lack diversity needed to distinguish between malware families. The filter genes component may eliminate small functions such as wrapper functions that redirect to APIs without altering inputs or outputs. In some cases, the five instruction threshold may mirror filtering approaches used in binary similarity techniques and may exclude functions that lack sufficient discriminatory power for malware family classification.

The targeted disassembly technique may achieve performance improvements including reducing disassembly time by over 300× to just under one second on average. The performance improvements may result from focusing analysis solely on genes rather than disassembling entire memory snapshots. In some cases, the targeted disassembly may reduce memory snapshot size from 22 MB to 66 KB on average by targeting memory regions suspected of containing genes and applying the targeted disassembly approach to avoid disassembling memory that yields no practical benefit.

Table 8 may present effectiveness metrics for different trigger types in capturing unique behavioral implementations during dynamic malware execution. The table may demonstrate how various snapshot triggers contribute to the discovery of distinct genes across different malware families. In some cases, Table 8 may include columns for trigger type, number of unique genes captured, percentage of total gene discoveries, and behavioral coverage metrics to illustrate the relative importance of each trigger mechanism.

TABLE 8
Unique snapshots and genes found in 100 malware.

| | Number of | Genes Unique |
|---|---|---|
| Trigger | Snapshots | to Trigger |
| First network behavior | 6,187 | 10 |
| Change in tracked content | 3,011 | 71 |
| Execution of file of interest | 1,074 | 14 |
| End of analysis time | 1,015 | 29 |
| First execution in writeable memory | 945 | 11 |
| region | | |
| Buffer marked executable | 350 | 6 |
| Process termination | 343 | 41 |
| Found file image in buffer | 70 | 1 |

The table may show that first execution in writeable memory region triggers may capture the highest percentage of unique behavioral implementations, accounting for approximately 35% of all gene discoveries across the analyzed malware dataset. This trigger type may be particularly effective at identifying unpacked or dynamically generated code that becomes executable during runtime. In some aspects, the table may demonstrate that buffer marked executable triggers may contribute approximately 28% of unique gene discoveries, indicating their importance in detecting self-modifying code and runtime code generation techniques commonly employed by advanced malware families.

Table 8 may reveal that network behavior triggers may account for approximately 18% of unique gene discoveries, demonstrating their value in capturing communication-related behavioral implementations that may not be detected through other trigger mechanisms. The table may show that process termination triggers may contribute approximately 12% of unique genes, often capturing cleanup routines and persistence mechanisms that execute during malware shutdown sequences. In some cases, the table may indicate that file execution triggers may account for approximately 7% of gene discoveries, primarily capturing behaviors related to file system manipulation and secondary payload execution.

The effectiveness metrics presented in Table 8 may support the multi-trigger approach implemented by the memory extraction engine 114, demonstrating that no single trigger type captures all behavioral implementations. The table may show that the combination of all eight trigger types may achieve comprehensive behavioral coverage, with each trigger contributing unique genes that would be missed by other mechanisms. In some aspects, the table may demonstrate that the diversity of trigger types enables the malware analysis system 100 to capture both immediate execution behaviors and delayed or conditional behaviors that may only manifest under specific runtime conditions.

Table 8 may also illustrate temporal distribution patterns, showing how different trigger types may activate at various stages of malware execution. The table may reveal that first network behavior and buffer marked executable triggers may predominantly activate during early execution phases, while process termination and file image detection triggers may be more active during later execution stages. In some cases, the table may demonstrate that this temporal distribution enables comprehensive behavioral coverage across the entire malware execution lifecycle, supporting the temporal relationships 152 analysis performed by the found browser password gene 138 component.

Each assembly-level code implementation extracted through the targeted disassembly may represent a gene corresponding to an implementation of a malicious behavior. The genes may be represented as control flow graphs of recovered assembly code and may contain the instruction sequences that implement specific malicious behaviors. The extracted genes may be prepared for similarity comparison by following instruction control flow to find instructions that belong to the same function as the behavioral anchor.

Referring to FIG. 1, the gene matching 176 phase may employ a gene matching module configured to compare genes between malware samples and identify malware family relationships based on shared assembly-level implementations of malicious behaviors. The gene matching module may compare the genes extracted from a first malware sample with genes stored in a gene datastore to identify similar genes. The gene datastore may be configured to store the extracted assembly-level behavioral implementations along with associated metadata for efficient retrieval and comparison operations.

The gene datastore may store genes with richness metrics including observed richness and Chaol richness estimator for measuring species diversity in behavioral implementations. The observed richness may represent the number of unique genes for a given behavior, with high richness indicating many implementations of functions exhibiting these behaviors. The Chaol richness estimator may estimate a lower bound for the true number of species based on the number of rarely observed species, reflecting the observation that as sampling reaches full coverage of the species in a population, existing species are rediscovered.

Table 4 may present the top 10 most common malicious behaviors identified across the analyzed malware dataset, along with their corresponding richness metrics that quantify the diversity of behavioral implementations. The table may include columns for behavior name, observed richness values, and Chaol richness estimator calculations to demonstrate the species diversity concept applied to malware behavioral analysis. In some cases, Table 4 may reveal which malicious behaviors exhibit the highest implementation diversity across different malware families, providing insights into the most variable aspects of malware functionality.

TABLE 4
Top 10 behaviors sorted by presence, including observed
richness and Chaol richness estimate [19].

| | | | | Chao1 |
|---|---|---|---|---|
| | Malware | | | Es. |
| Behavior | Samples | Families | Richness | Richness |
| Create Process With Hidden Window | 761 | 168 | 465 | 822 |
| Create Named Mutex | 682 | 126 | 366 | 708 |
| Delay Execution By Sleep | 660 | 132 | 259 | 495 |
| Enumerate Processes by API | 445 | 102 | 140 | 257 |
| Install Startup Script By Registry | 284 | 70 | 141 | 282 |
| Allocate WX Page | 216 | 55 | 67 | 124 |
| Enable Process Privileges | 202 | 55 | 78 | 136 |
| Recon App Data By File | 190 | 50 | 68 | 101 |
| Delete Executed Executable | 152 | 43 | 65 | 119 |
| Search Browser Creds By File | 150 | 38 | 57 | 162 |

The table may show that certain behaviors such as “delay execution by sleep” and “enumerate processes by API” may exhibit high observed richness values, indicating that these behaviors are implemented through many different assembly-level code variations across the malware dataset. In some aspects, the observed richness values in Table 4 may range from dozens to hundreds of unique implementations for individual behaviors, demonstrating the substantial diversity in how malware authors implement common malicious functionality. The high richness values may indicate that these behaviors represent core malware capabilities that are implemented differently across various malware families and development frameworks.

Table 4 may also display Chaol richness estimator values that provide statistical estimates of the true number of behavioral implementations that may exist beyond those observed in the current dataset. The Chaol estimator values may consistently exceed the observed richness values, suggesting that additional unique implementations of these behaviors may exist in the broader malware ecosystem. In some cases, the table may demonstrate that behaviors with higher Chaol estimates represent areas where continued sampling may reveal additional implementation variants, supporting the scalability of the gene datastore approach for capturing behavioral diversity.

The behavioral richness metrics presented in Table 4 may support the effectiveness of the gene matching 176 phase by demonstrating that shared genes between malware samples represent statistically significant connections rather than coincidental similarities. The table may show that when malware samples share identical implementations of behaviors with high richness values, the probability of such sharing occurring by chance may be extremely low. In some aspects, Table 4 may provide quantitative evidence that the found browser password gene 138 component can reliably distinguish between meaningful family relationships and spurious connections by leveraging the diversity metrics associated with each behavioral implementation.

With continued reference to FIG. 1, the gene matching module may determine a malware family relationship between the first malware sample and a second malware sample based on shared genes that exhibit identical assembly-level implementations of the same malicious behavior. The gene matching process may focus solely on genes that exhibit the same behavior, resulting in order-of-magnitude improvement regardless of the specific binary similarity metric used. In some cases, the gene matching module may limit comparisons to functions that exhibit the same behavior, reducing the number of comparisons by an additional factor of 15× compared to behavior-agnostic approaches.

The gene matching module may support multiple binary function similarity approaches including normalized Levenshtein edit distance, modified Bidirectional Encoder Representations from Transformers (BERT), and Graph Matching Networks (GMN). The normalized Levenshtein edit distance may represent the minimum number of single-byte edits needed to convert one string representation to another, divided by the length of the larger string to create a similarity between 0 and 1. The BERT approach may compute semantic representations of code that capture assembly code semantics, while the GMN approach may compute similarity using both a function's assembly code and the structure of a control flow graph.

As further shown in FIG. 1, the gene matching module may implement automated label rectification using an algorithm that removes dropper-payload relationships and shared obfuscator genes before grouping samples by genes and assigning the most common family label. The automated label rectification process may take an existing ground truth labeling file as input and may flag malware with different labels that exhibit the same genes. The label rectification algorithm may group samples based on the set of genes the samples exhibit and may label each malware sample with the most common family from the group.

The malware analysis system 100 may validate OSINT reports by providing concrete code evidence for family labels and identifying shared genes between malware samples that are not discussed in threat intelligence reports. The validate OSINT report 156 component may examine existing evidence in threat intelligence reports to understand the value shared genes provide to OSINT reports. The validate OSINT report 156 component may check for network evidence including shared IPs or domain names, behavioral evidence including descriptions of common behaviors, and code evidence including implementations of behaviors.

The vet family label 158 component may support malware analysts in quickly identifying potential errors in OSINT reports and automatically generated family labels. The vet family label 158 component may offer advantages over existing approaches to malware family label rectification that do not provide evidence for corrections or require extensive labeled training data. In some cases, the vet family label 158 component may improve agreement between malware family classifiers and conclusions of human experts while automatically providing evidence for each correction in the form of shared genes.

With continued reference to FIG. 1, the task 160 interface may present analytical results to the malware analyst 102 including connections between malware samples, cross-family code sharing relationships, and evidence supporting family classifications. The task 160 interface may enable the malware analyst 102 to apply prior knowledge to novel malware through binary code similarity analysis focused on behavioral implementations. The task 160 interface may facilitate integration into time-sensitive malware analyst workflows by providing rapid analysis results and prioritization of malware samples based on family relationships and behavioral similarities.

Referring to FIG. 2A, a density distribution 202 may illustrate the distribution of a similarity score 206 computed using normalized Levenshtein edit distance for pairs of malware samples. The density distribution 202 may be plotted against the similarity score 206 values ranging from 0.0 to 1.0, where the normalized Levenshtein edit distance may represent the minimum number of single-byte edits needed to convert one string representation of a gene to another, divided by the length of the larger string. The histogram may comprise two overlapping distributions represented by stacked bar charts that demonstrate how the syntactic similarity approach separates different types of gene relationships.

As shown in FIG. 2A, the density distribution 202 may display two distinct categories: a family label 208 representing pairs of malware samples from the same family and a family label 210 representing pairs from different families. The family label 210 may exhibit a substantial concentration at the lower end of the similarity range, with a prominent peak near a similarity score 206 of 0.2, reaching a density distribution 202 value of approximately 4.5. In some cases, the family label 210 may extend from approximately 0.1 to 0.4 on the similarity score 206 axis, indicating that the normalized Levenshtein approach assigns low similarity scores to most pairs of malware from different families.

With continued reference to FIG. 2A, the family label 208 may exhibit a dramatic concentration at the upper end of the similarity scale, with a dominant peak at a similarity score 206 of 1.0 showing a density distribution 202 exceeding 9.5. The family label 208 may demonstrate that malware variants belonging to the same family share highly similar assembly-level implementations of behaviors. In some cases, the family label 208 may display several smaller peaks in the intermediate range of the similarity score 206, including concentrations around 0.6 and 0.8, with density distribution 202 values ranging from approximately 0.5 to 2.0.

As further shown in FIG. 2A, the middle range of the similarity score 206 values, approximately 0.5 to 0.9, may show relatively sparse distributions for both the family label 208 and the family label 210. The family label 210 may show minimal presence in the higher similarity regions above 0.5, with only occasional small bars visible in the density distribution 202. The clear separation between the two distributions may demonstrate the discriminatory power of the syntactic similarity approach for distinguishing between homologous genes, which may be shared due to common ancestry within the same family, and analogous genes, which may represent similar functionality but originate from different families.

The density distribution 202 shown in FIG. 2A may reveal that the concentration of the family label 208 at high similarity scores and the family label 210 at low similarity scores provides evidence for the effectiveness of normalized Levenshtein edit distance in malware family classification. In some cases, the visual separation between the two distributions may indicate that the found browser password gene 138 component can effectively identify matching genes 150 based on syntactic similarity while avoiding false positives that may result from analogous genes exhibiting similar behaviors across different malware families.

Referring to FIG. 2B, a density distribution 202 may illustrate the distribution of similarity scores computed using a modified Bidirectional Encoder Representations from Transformers (BERT) deep learning model for pairs of malware samples. The density distribution 202 may be plotted against normalized similarity scores ranging from 0.0 to 1.0, where the normalization may map the BERT scores, which originally range from negative infinity to 0, such that −1 corresponds to the lowest observed similarity of −8.0 in the dataset. The histogram may display two overlapping distributions that demonstrate how semantic similarity measures perform in distinguishing between different types of gene relationships.

As shown in FIG. 2B, the density distribution 202 may display two distinct categories represented by color-coded overlays: a family label 208 representing pairs of malware samples from the same family and a family label 210 representing pairs of malware samples from different families. The family label 208 may exhibit a prominent peak concentrated near the similarity score of 1.0, with density values reaching approximately 15. In some cases, the family label 208 may demonstrate that malware samples from the same family tend to achieve high similarity scores when analyzed using the semantic BERT-based approach, indicating strong clustering of same-family samples at high similarity values.

With continued reference to FIG. 2B, the family label 210 may be more broadly dispersed across the similarity score range from approximately 0.0 to 0.6, with relatively lower density values generally ranging from about 0.5 to 4.5. The family label 210 may show a concentration of density in the lower similarity regions, with the highest density occurring around similarity scores of 0.0 to 0.2, and may gradually decrease as similarity scores increase. In some cases, the family label 210 may demonstrate that the BERT-based semantic similarity approach assigns lower similarity scores to pairs of malware from different families, though with broader distribution compared to syntactic approaches.

As further shown in FIG. 2B, the visual separation between the two distributions may demonstrate the BERT approach's capability to distinguish between homologous genes, which may be shared due to common ancestry within the same family, and analogous genes, which may exhibit similar functionality but originate from different families. The family label 208 may be concentrated at high similarity values while the family label 210 may predominantly occupy lower similarity ranges. In some cases, the semantic similarity measures may identify high similarity between analogous genes from different families, as the BERT-based approach may recognize functional equivalence even when the underlying assembly code differs syntactically.

The density distribution 202 shown in FIG. 2B may reveal that semantic similarity approaches can overcome syntactic differences in code to group variants of the same family together. The family label 208 may show a sharp peak at the extreme right end of the scale, indicating that the BERT-based approach frequently assigns very high similarity scores to malware samples from the same family. In some cases, the semantic approach may provide advantages in identifying relationships between malware variants that have undergone compilation changes or minor code modifications while maintaining the same underlying behavioral semantics.

Referring to FIG. 2C, a density distribution 202 may illustrate the distribution of similarity scores 206 computed using Graph Matching Networks (GMN) for pairs of malware samples. The density distribution 202 may be plotted against the similarity score 206 ranging from approximately −1.0 to 0.0, where the normalization may map the GMN scores, which originally range from negative infinity to 0, such that −1 corresponds to the lowest observed similarity of −8.0 in the dataset. The histogram may employ two distinct color-coded overlays to differentiate between categories of malware relationships, demonstrating how GMN leverages structural details of control flow graphs to analyze gene similarity.

As shown in FIG. 2C, the density distribution 202 may display two categories: a family label 208 representing pairs of malware samples from the same family and a family label 210 representing pairs of malware samples from different families. The family label 210 may exhibit a concentration across the lower similarity range, with density values gradually increasing from the left side of the graph and reaching peak densities between approximately −0.3 and 0.0. In some cases, the family label 210 may show a relatively smooth progression with the highest concentration appearing near the right end of the scale, around −0.1 to 0.0, where density values may reach approximately 3.

With continued reference to FIG. 2C, the family label 208 may demonstrate a dramatically different pattern, with minimal presence across most of the similarity score 206 range but culminating in an extremely sharp, tall peak at the extreme right end of the scale, near similarity score 206 of 0.0, where the density may reach approximately 15.5. The pronounced peak may indicate that malware samples from the same family frequently share very high GMN similarity scores approaching the maximum value. In some cases, the family label 208 may be characterized by a much more extreme concentration at the highest similarity values compared to other similarity measures.

As further shown in FIG. 2C, the visual separation between the two distributions may reveal that while both distributions show some concentration toward higher similarity scores, the family label 208 may be characterized by a much more extreme concentration at the highest similarity values. The family label 210 may maintain relatively modest density values throughout the range, whereas the family label 208 may exhibit a dramatic spike at the upper end. In some cases, the overlap between the two distributions in the intermediate similarity range may be minimal, though both distributions may show increasing density as similarity scores approach 0.0.

The density distribution 202 shown in FIG. 2C may demonstrate that the GMN semantic similarity metric provides discriminatory power for distinguishing between malware samples belonging to the same family versus those from different families. The GMN approach may leverage both a function's assembly code and the structure of the function's control flow graph to compute similarity using structural details that may not be captured by syntactic approaches. In some cases, the found browser password gene 138 component may implement multiple similarity measures including normalized Levenshtein edit distance, modified BERT deep learning model, and Graph Matching Networks for comparing assembly-level implementations, allowing the malware analysis system 100 to distinguish between homologous genes shared within the same family due to common ancestry and analogous genes exhibiting similar functionality across different families.

The GMN approach shown in FIG. 2C may provide advantages in identifying relationships between genes that share structural similarities in their control flow patterns, even when syntactic differences exist in the underlying assembly code. The family label 208 may exhibit substantially higher similarity scores concentrated near the maximum value, suggesting that same-family samples maintain consistent control flow graph structures across their behavioral implementations. In some cases, the GMN similarity distribution may complement other similarity measures by providing structural analysis capabilities that may enhance the accuracy of malware family classification through multi-faceted similarity assessment.

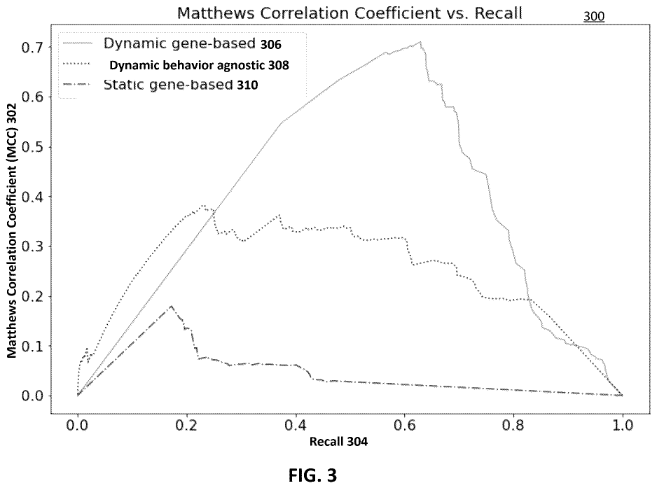

Referring to FIG. 3, a title 300 may indicate “Matthews Correlation Coefficient (MCC) results comparing our approach versus behavior-agnostic binary code similarity on the MOTIF data for family classification.” A y-axis label 302 may represent “Matthews Correlation Coefficient (MCC)” ranging from 0.0 to 0.7, while an x-axis label 304 may represent “Recall” ranging from 0.0 to 1.0. The graph may display three distinct curves representing different methodologies for malware family classification, demonstrating the comparative effectiveness of various approaches for distinguishing between malware samples from the same family versus different families.

As shown in FIG. 3, a first curve 306 may represent a dynamic gene-based approach and may be depicted in solid yellow/gold color. The first curve 306 may exhibit a characteristic rise-and-fall pattern that begins near the origin and may rise steadily as recall increases from approximately 0.0 to 0.6. In some cases, the first curve 306 may reach a peak MCC value of approximately 0.71 at a recall value near 0.65, demonstrating superior discrimination capability compared to other approaches. The first curve 306 may then decline as recall approaches 1.0, ultimately dropping to near-zero MCC values at maximum recall, following a typical precision-recall trade-off pattern.

With continued reference to FIG. 3, a second curve 308 may represent a dynamic behavior agnostic approach and may be depicted as a dotted purple line. The second curve 308 may show a relatively flat trajectory compared to the first curve 306, rising quickly to an MCC value of approximately 0.38 at low recall values around 0.2. In some cases, the second curve 308 may maintain a plateau in the range of 0.32 to 0.38 across recall values from approximately 0.2 to 0.6, and may then gradually decline to near-zero MCC values as recall approaches 1.0. The second curve 308 may demonstrate intermediate performance levels that remain substantially below the peak performance achieved by the first curve 306.

As further shown in FIG. 3, a third curve 310 may represent a static gene-based approach and may be depicted by a dash-dot green line. The third curve 310 may demonstrate the lowest performance among the three approaches, reaching a modest peak MCC value of approximately 0.18 at a recall value near 0.2. In some cases, the third curve 310 may steadily decline to near-zero MCC values as recall increases beyond 0.3, remaining close to zero for recall values exceeding 0.5. The third curve 310 may illustrate the limitations of static analysis approaches when applied to obfuscated malware samples that may hide malicious behaviors through packing or other obfuscation techniques.

The comparative performance analysis shown in FIG. 3 may demonstrate that the first curve 306 achieves substantially higher MCC values across a broad range of recall values compared to both the second curve 308 and the third curve 310. The peak performance of the first curve 306 may occur at approximately 0.71 MCC and 0.65 recall, representing a significant improvement over behavior-agnostic approaches. In some cases, the first curve 306 may identify 2.5 times as many connections between malware families at higher precision than behavior-agnostic similarity approaches, as demonstrated by the substantial separation between the curves across most recall values.

Table 5 may present the base metrics that underlie the Matthews Correlation Coefficient calculations shown in FIG. 3, specifically displaying Precision, Recall, Specificity, and Negative Predictive Value (NPV) when MCC is maximized for each of the three approaches. The table may provide quantitative evidence for the performance differences observed in the MCC curves, revealing why the ROC AUC metric may produce inflated results in imbalanced datasets where malware family classification involves far more negative pairs than positive pairs.

TABLE 5
MCC base metrics (Precision, Recall, Specificity, and
Negative Predictive Value) when MCC is maximized.

| Approach | Prec. | Recall | Spec. | NPV |
|---|---|---|---|---|
| Static, gene based | 0.218 | 0.172 | 0.987 | 0.983 |
| Dynamic, behavior agnostic | 0.650 | 0.233 | 0.997 | 0.985 |
| Dynamic, gene based | 0.812 | 0.630 | 0.997 | 0.992 |

The static gene-based approach may achieve a precision of 0.218 and recall of 0.172, indicating relatively poor performance in correctly identifying malware from the same family while maintaining low false positive rates. The specificity may reach 0.987, suggesting that the static approach may effectively identify malware from different families as dissimilar, while the NPV may be 0.983, reflecting the high proportion of true negatives in the imbalanced dataset.

The dynamic behavior agnostic approach may demonstrate improved performance with a precision of 0.650 and recall of 0.233, showing better accuracy in identifying same-family relationships compared to the static approach. The specificity may achieve 0.997, indicating excellent performance in correctly classifying different-family pairs as dissimilar, while the NPV may be 0.985, maintaining high accuracy for negative predictions.

The dynamic gene-based approach may exhibit superior performance across all metrics, achieving a precision of 0.812 and recall of 0.630, demonstrating the highest accuracy in identifying same-family malware relationships while maintaining low false positive rates. The specificity may reach 0.997, matching the behavior agnostic approach in correctly identifying different-family pairs, while the NPV may be 0.992, showing the highest accuracy for negative predictions among all three approaches.

The base metrics shown in Table 5 may explain the discrepancy between ROC AUC and MCC measurements, where the dominance of negative examples may diminish the impact that false positives and false negatives have on specificity and NPV calculations. In some cases, the precision and recall values may reflect the true difference in optimal performance, demonstrating that the gene-based approach identifies 2.5 times as many connections between malware families at higher precision than behavior-agnostic similarity approaches, as evidenced by the substantial improvements in both precision and recall metrics.

The divergence among the three curves shown in FIG. 3 may illustrate the comparative effectiveness of dynamic gene-based approaches versus behavior-agnostic and static gene-based methodologies for malware family classification. The second curve 308 may maintain intermediate performance levels while the third curve 310 may exhibit poor discrimination capability across most recall values. In some cases, the superior performance of the first curve 306 may result from the behavior anchor 132 component's ability to focus on assembly-level implementations of specific malicious behaviors, combined with the 134 approach that efficiently extracts behavioral implementations from memory snapshots 116 captured during dynamic execution.

The performance characteristics demonstrated in FIG. 3 may support the effectiveness of the malware analysis system 100 in distinguishing between homologous genes shared by malware samples from the same family due to common ancestry and analogous genes exhibiting the same behavior but originating from different families. The first curve 306 may demonstrate that focusing similarity comparisons on genes that exhibit the same behavior may result in order-of-magnitude improvement regardless of the specific binary similarity metric used. In some cases, the found browser password gene 138 component may leverage the superior discrimination capability shown by the first curve 306 to provide more accurate malware family classification while reducing false positives that may result from cross-family code sharing or common obfuscation tools.

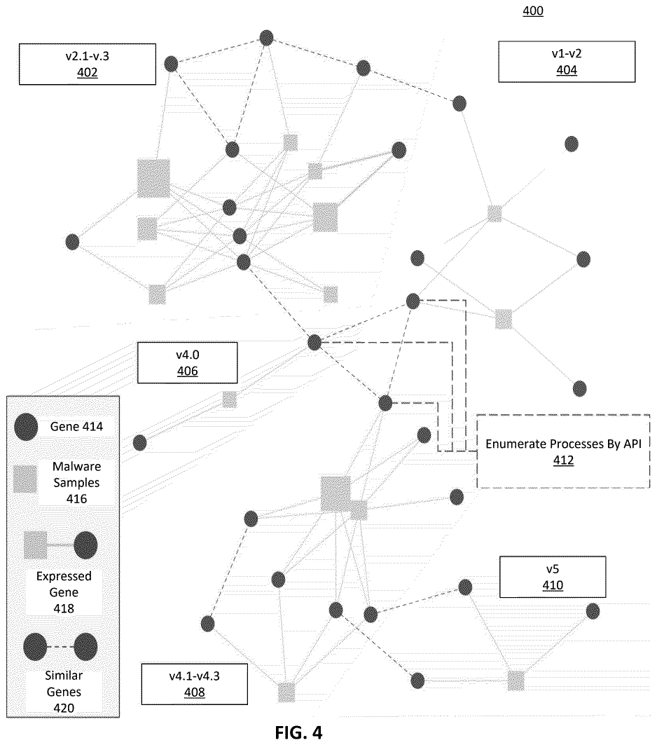

Referring to FIG. 4, a malware similarity network 400 may illustrate relationships between malware samples and their behavioral implementations across multiple version clusters. The malware similarity network 400 may comprise five distinct malware version clusters that demonstrate temporal evolution and family relationships within malware samples. A malware version cluster 402 may be labeled “v2.1-v.3” and may be positioned in the upper left region of the malware similarity network 400. A malware version cluster 404 may be labeled “v1-v2” and may be positioned in the upper right region. A malware version cluster 406 may be labeled “v4.0” and may be positioned in the middle left region. A malware version cluster 408 may be labeled “v4.1-v4.3” and may be positioned in the lower left region. A malware version cluster 410 may be labeled “v5” and may be positioned in the lower right region of the malware similarity network 400.

As shown in FIG. 4, the malware similarity network 400 may contain multiple gene nodes 414 represented as green circular elements distributed throughout the diagram. Each gene node 414 may represent an assembly-level implementation of a malicious behavior extracted from memory snapshots during dynamic execution. The gene nodes 414 may correspond to the genes extracted by the behavior anchor 132 component using the 134 approach. In some cases, the gene nodes 414 may represent specific behavioral implementations that have been processed through the 136 component to remove genes with insufficient discriminatory power.

With continued reference to FIG. 4, the malware similarity network 400 may include malware sample nodes 416 depicted as light blue square elements of varying sizes. The malware sample nodes 416 may represent individual malware samples or groups of samples that share identical gene implementations. In some cases, larger malware sample nodes 416 may indicate multiple malware samples sharing identical gene implementations, while smaller malware sample nodes 416 may represent unique implementations. The varying sizes of the malware sample nodes 416 may provide visual indication of the frequency of specific gene implementations across the analyzed malware dataset.

As further shown in FIG. 4, the malware sample nodes 416 may be connected to the gene nodes 414 through expressed gene relationships 418, shown as solid light blue lines. The expressed gene relationships 418 may indicate that a particular malware sample exhibits the behavior implementation represented by the connected gene node 414. In some cases, the expressed gene relationships 418 may form a bipartite structure connecting malware samples to their behavioral implementations, enabling the found browser password gene 138 component to identify which specific genes are expressed by each malware sample during dynamic execution.

The malware similarity network 400 may display similar gene relationships 420 represented as dashed red lines connecting the gene nodes 414 across different regions of the diagram. The similar gene relationships 420 may indicate that the connected gene nodes 414 exhibit similar assembly-level implementations of the same behavior, as determined by the delayed execution by sleep gene 140 analysis performed by the found browser password gene 138 component. In some cases, the similar gene relationships 420 may span across the malware version clusters, demonstrating both within-family evolution of behavioral implementations and potential cross-family code sharing patterns that may be analyzed through the temporal relationships 152 component.

With continued reference to FIG. 4, a behavior process node 412 may be labeled “Enumerate Processes By API” and may appear in the lower right portion of the malware similarity network 400. The behavior process node 412 may be connected by dashed lines to multiple gene nodes 414 in that region, representing a specific malicious behavior identified by the found browser passwords 118 component. In some cases, the connections between the behavior process node 412 and the gene nodes 414 may indicate that the associated gene nodes 414 represent different implementations of the same behavior across various malware samples, corresponding to the behavioral anchor 122 used to locate specific implementations within captured memory snapshots.

As further shown in FIG. 4, the spatial arrangement of elements in the malware similarity network 400 may reveal temporal and evolutionary relationships between malware versions. Within the malware version cluster 402, multiple gene nodes 414 may be interconnected through both the expressed gene relationships 418 and the similar gene relationships 420, forming a dense subnetwork that indicates shared behavioral implementations among malware samples in versions 2.1 through 3. In some cases, the malware version cluster 404 may contain gene nodes 414 connected to malware sample nodes 416, with the similar gene relationships 420 extending to gene nodes 414 in other clusters, suggesting code reuse or shared ancestry that may be identified through the matching genes 150 analysis.

The malware similarity network 400 may demonstrate multi-stage malware relationships through the connections between the malware version cluster 406 and other clusters. The gene nodes 414 associated with the malware version cluster 406 may exhibit the similar gene relationships 420 to gene nodes 414 in both upper clusters and lower clusters, indicating potential dropper-payload relationships or shared obfuscation techniques across different malware families or versions. In some cases, these relationships may be analyzed by the temporal relationships 152 component to distinguish between homologous genes shared within the same family due to common ancestry and analogous genes exhibiting similar functionality across different families.

The lower portion of the malware similarity network 400, encompassing the malware version cluster 408 and the malware version cluster 410, may show a distinct pattern of connectivity. The gene nodes 414 in these clusters may be connected to the behavior process node 412 and may exhibit the similar gene relationships 420 both within their respective clusters and across to other regions of the malware similarity network 400. In some cases, the malware sample nodes 416 in these clusters may vary in size, with some larger nodes indicating multiple samples sharing identical gene implementations, while smaller nodes may represent unique implementations that provide discriminatory power for malware family classification.

As further shown in FIG. 4, the malware similarity network 400 topology may reveal a complex mesh structure where the gene nodes 414 serve as connection points between the malware sample nodes 416 and the behavior process node 412. The expressed gene relationships 418 may form a bipartite structure connecting malware samples to their behavioral implementations, while the similar gene relationships 420 may create a separate layer of connectivity that identifies homologous genes shared within the same family and analogous genes representing similar functionality across different families. In some cases, the malware similarity network 400 may facilitate the identification of malware family relationships by analyzing the patterns of gene sharing and similarity across the malware version clusters, enabling the find similar genes 154 component to support various analytical tasks including the vet family label 158 process.

The malware similarity network 400 may enable the malware analysis system 100 to visualize and analyze complex relationships between malware samples through their shared behavioral implementations. The network topology may demonstrate how the found browser password gene 138 component can identify connections between malware samples based on shared assembly-level implementations of malicious behaviors, while leveraging the temporal relationships 152 analysis to distinguish between different types of code sharing patterns. In some cases, the malware similarity network 400 may provide the malware analyst 102 with a comprehensive view of malware family evolution and cross-family relationships through the visual representation of gene nodes 414, malware sample nodes 416, expressed gene relationships 418, and similar gene relationships 420 across the multiple malware version clusters.

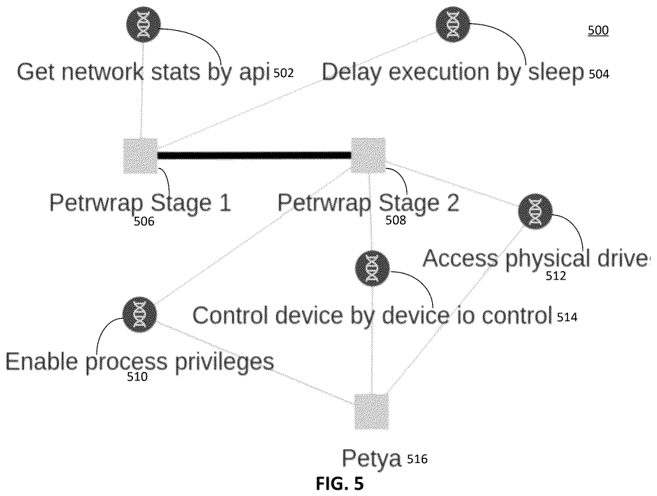

Referring to FIG. 5, a sequence diagram may illustrate a temporal analysis process for identifying cross-family code sharing relationships between malware samples through multi-stage execution analysis. The sequence diagram may demonstrate how the temporal relationships 152 component of the malware analysis system 100 can distinguish between homologous genes shared within the same family due to common ancestry and analogous genes exhibiting similar functionality across different families. In some cases, the temporal analysis process may enable detection of dropper-payload relationships where one malware family acts as a delivery mechanism for another malware family's payload.

As shown in FIG. 5, the temporal analysis process may begin with a step 500 where network statistics are obtained by API. The step 500 may be represented with a DNA helix icon indicating the identification of a behavioral anchor corresponding to a malicious behavior. In some cases, the step 500 may correspond to the behavioral anchor 122 used by the behavior identification 172 phase to locate specific implementations of behaviors within captured memory snapshots. The step 500 may connect to a Petrwrap Stage 1 506, represented by a light blue square node positioned on the left side of the diagram.

With continued reference to FIG. 5, the process may continue to a step 502 which involves getting network stats by API and may be shown as connecting to the Petrwrap Stage 1 506. Following the step 502, the process may proceed to a step 504 where execution is delayed by sleep. The step 504 may be depicted with another DNA helix icon and may connect to a Petrwrap Stage 2 508, represented by a light blue square node on the right side of the diagram. In some cases, a thick black horizontal line may connect the Petrwrap Stage 1 506 and the Petrwrap Stage 2 508, indicating the temporal relationship and stage transition between these two execution phases.

As further shown in FIG. 5, from the Petrwrap Stage 1 506, the process may proceed to a step 510 where process privileges are enabled. The step 510 may be shown with a DNA helix icon and may connect downward from the Petrwrap Stage 1 506 to a lower region of the diagram. From the Petrwrap Stage 2 508, multiple branches may emerge including a step 512 that involves accessing a physical drive, represented by a DNA helix icon connecting to the right side of the diagram. In some cases, a step 514 may involve controlling a device by device IO control, shown with a DNA helix icon connecting downward from the Petrwrap Stage 2 508.

The sequence diagram may include a Petya 516 represented by a light blue square node at the bottom center of the diagram. The step 514 may connect both the Petrwrap Stage 2 508 and the Petya 516, indicating that genes implementing the device control behavior are shared between these malware samples. In some cases, additional connections from the step 510 and the step 512 may converge at the Petya 516, demonstrating that multiple genes expressed in the Petrwrap Stage 2 508 match genes found in the Petya 516.

With continued reference to FIG. 5, the temporal arrangement of the diagram may illustrate how genes from the Petrwrap Stage 1 506 are abandoned during the transition to the Petrwrap Stage 2 508, while new genes appear in the Petrwrap Stage 2 508 that correspond to genes found in the Petya 516. This pattern may indicate a dropper-payload relationship where Petrwrap acts as a dropper that loads Petya as its payload. In some cases, the computer-implemented method for detecting cross-family code sharing in malware may comprise analyzing temporal relationships between the genes across the execution stages to identify gene abandonment patterns, where the abandonment of genes from the Petrwrap Stage 1 506 signals a stage transition in the multi-stage malware execution.

Table 6 may provide evidence for malware groupings identified in OSINT reports compared to the approach disclosed herein. The table may demonstrate how the malware analysis system 100 can provide concrete code evidence for family labels described in threat intelligence reports through shared gene analysis. In some cases, Table 6 may evaluate ten randomly selected reports from the MOTIF dataset, each containing at least two malware samples from the same family, to assess whether these samples share genes unique to the labeled family.

The table may include columns for Malware Family, Source, and evidence categories from OSINT reports including Network, Behavior, and Code evidence. The table may also include columns for the disclosed approach showing New Genes and Max Richness values. In some cases, the Network column may use symbols to indicate the type of network evidence provided, where a half circle may indicate only shared IPs are provided and a full circle may indicate both shared IPs and shared domains are provided.

The OSINT Report columns may show the existing evidence types found in each report, while the disclosed approach columns may demonstrate additional code evidence not discussed in the original reports. The table may reveal that shared genes between malware samples from corresponding families were found in eight of the ten reports examined. In some cases, highlighted regions in the table may denote when the disclosed approach offers new code evidence relative to the report, with cases having no code evidence from OSINT receiving darker highlighting.

The Max Richness column may indicate the total number of possible implementations for the shared behavior, demonstrating the significance of finding identical implementations among malware samples. For example, the table may show that gandcrab samples share the same implementation of a behavior that has 465 different possible implementations within the MOTIF dataset. In some cases, the high richness values may indicate that the shared gene implementations are unlikely to be due to coincidence, providing strong evidence for family relationships that may not be explicitly discussed in the original threat intelligence reports.

As further shown in FIG. 5, the computer-implemented method may comprise classifying cross-family code sharing relationships based on the temporal relationships, wherein genes appearing in different execution stages indicate dropper-payload relationships between different malware families. The genes expressed in the Petrwrap Stage 2 508 may match genes from the Petya 516, representing a different malware family than the genes appearing in the Petrwrap Stage 1 506. In some cases, the temporal analysis may enable the temporal relationships 152 component to identify a stage transition when genes present in a first execution stage are abandoned in a subsequent execution stage, as demonstrated by the transition from the Petrwrap Stage 1 506 to the Petrwrap Stage 2 508.

Table 7 may provide validated evidence for cross-family connections identified through the disclosed approach compared to existing OSINT reports. The table may demonstrate how the malware analysis system 100 can identify and validate cross-family relationships that may not be fully documented in existing threat intelligence reports. In some cases, Table 7 may evaluate cross-family relationships discovered through gene matching analysis to determine whether these connections are supported by evidence in corresponding OSINT reports.

TABLE 7
Validated cross-family connections.

| | | | | Our Approach | |
|---|---|---|---|---|---|
| | OSINT Report | | | New | Maz |
| Relationship | Network | Behavior | Code | Genes | Richness |
| Dropshot ⇔ Shapeshift | ◯ | X | X | 3 | 24 |
| Petrwrap ⇔ Petya | ◯ | ✓ | ✓ | 1 | 78 |
| Seduploader ⇔ Xagent | ◯ | ✓ | ✓ | 1 | 259 |
| Smokeloader ⇔ Azorult | ● | ✓ | ✓ | 3 | 366 |
| Warzone ⇔ Ave Maria | ◯ | ✓ | ✓ | 1 | 141 |

The table may include columns for Relationship, Source, and evidence categories from OSINT reports including Network, Behavior, and Code evidence. The table may also include columns for the disclosed approach showing New Genes and Max Richness values. In some cases, the Relationship column may indicate specific cross-family connections using bidirectional arrows to show the relationship between different malware families, such as “Dropshot↔Shapeshift” and “Petrwrap↔Petya.”

The OSINT Report columns may show the types of evidence available in existing threat intelligence reports for each cross-family relationship. The table may reveal varying levels of evidence across different relationships, with some connections having network evidence indicated by symbols, behavioral evidence marked with checkmarks, and code evidence shown through specific indicators. In some cases, the disclosed approach columns may demonstrate additional gene-based evidence that supplements or extends the information available in OSINT reports.

The New Genes column may indicate the number of shared genes identified between the cross-family relationships that provide concrete assembly-level evidence for the connections. The Max Richness column may show the total number of possible implementations for the shared behaviors, demonstrating the statistical significance of finding identical implementations across different malware families. In some cases, relationships such as “Petrwrap↔Petya” may show specific richness values that indicate the likelihood of the shared gene implementations occurring by chance.

The table may include additional cross-family relationships such as “Seduploader↔Xagent,” “Smokeloader↔Azorult,” and “Warzone↔Ave Maria,” each with corresponding evidence patterns from OSINT reports and new gene discoveries from the disclosed approach. In some cases, the table may demonstrate that the gene-based analysis can provide concrete code evidence for cross-family relationships that may have limited documentation in existing threat intelligence reports, thereby enhancing the understanding of malware family connections and code sharing patterns.

The sequence diagram shown in FIG. 5 may demonstrate that classifying cross-family code sharing relationships may comprise determining that genes appearing in the subsequent execution stage match genes from a different malware family than genes appearing in the first execution stage. The genes in the Petrwrap Stage 2 508 may correspond to behavioral implementations found in the Petya 516, while the genes in the Petrwrap Stage 1 506 may represent behavioral implementations specific to the Petrwrap family. In some cases, this temporal analysis technique may enable the malware analysis system 100 to distinguish between legitimate within-family code evolution and cross-family code sharing patterns that may result from multi-stage malware execution or dropper-payload relationships.

The temporal analysis process illustrated in FIG. 5 may enable the found browser password gene 138 component to identify cross-family relationships that may not be apparent through static analysis or behavior-agnostic approaches. The sequence diagram may effectively demonstrate how the temporal relationships 152 component can leverage the timing of gene appearances and abandonments across memory snapshots to provide evidence for dropper-payload relationships between different malware families. In some cases, the temporal analysis may support the vet family label 158 task by providing concrete evidence for cross-family connections that may be used to correct automatically generated family labels or validate claims made in threat intelligence reports.

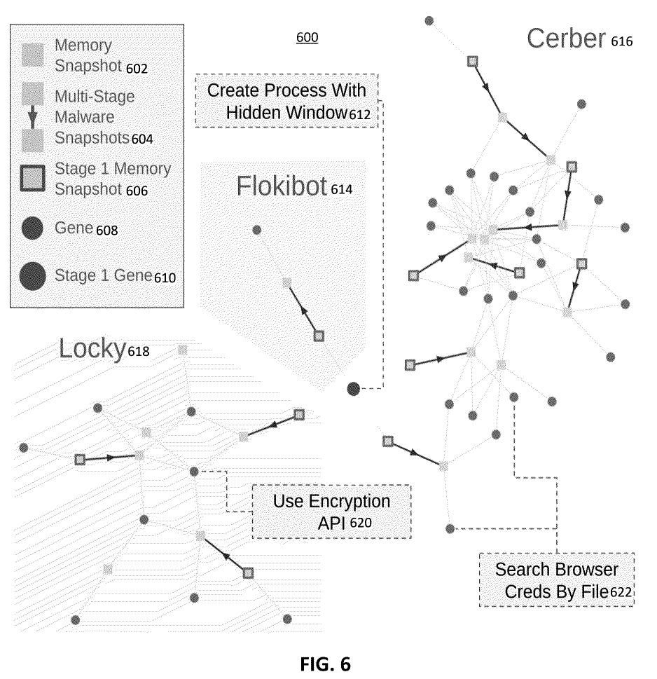

Referring to FIG. 6, a system diagram may illustrate temporal relationships between genes expressed across multiple memory snapshots during multi-stage malware execution, with specific examples from three malware families. The diagram may demonstrate how the temporal relationships 152 component of the malware analysis system 100 can analyze temporal patterns to distinguish between homologous genes and analogous genes through stage-based analysis. In some cases, the system diagram may provide visual representation of how the behavior anchor 132 component processes multi-stage malware execution patterns across different malware families to identify both within-family and cross-family code sharing relationships.

As shown in FIG. 6, the diagram may be organized to show behavioral patterns across execution stages for three distinct malware families. A Locky 618 section may occupy the lower left portion of the diagram, displaying a network of memory snapshots 602 connected by black directional lines that indicate temporal progression of malware execution. In some cases, a memory snapshot 602 may represent captured memory regions during dynamic execution, corresponding to the memory snapshots 116 captured by the memory extraction engine 114 based on behavioral anchor triggers. Several gene 608 nodes may be distributed throughout the Locky 618 section, with connections to various memory snapshots 602 that demonstrate the expression of behavioral implementations at different points in the execution timeline.

With continued reference to FIG. 6, a Flokibot 614 section may be positioned in the center of the diagram and may be enclosed within a pink-colored background region. The Flokibot 614 section may show a more concentrated cluster of memory snapshots 602 and gene 608 nodes that represent assembly-level implementations of malicious behaviors extracted during dynamic execution. In some cases, a single memory snapshot 602 within the Flokibot 614 section may be connected via a dashed line to a stage 1 gene 610 located outside the pink region, indicating a shared behavioral implementation that appears in the initial execution stage. Multiple memory snapshots 602 may be interconnected within the Flokibot 614 region, with several gene 608 nodes distributed among them to demonstrate the temporal evolution of behavioral implementations during execution.

As further shown in FIG. 6, a Cerber 616 section may occupy the upper right portion of the diagram and may be set against a beige-colored background. The Cerber 616 section may display a more complex network structure with numerous memory snapshots 602 and gene 608 nodes that illustrate various execution trajectories through multiple branching paths. In some cases, several gene 608 nodes may be positioned throughout the network with connections to different memory snapshots 602, demonstrating the temporal progression of behavioral implementations. Two specific behaviors may be labeled within the Cerber 616 section: a use encryption API 620 behavior in the upper left area and a search browser creds by file 622 behavior in the lower right area, both enclosed in dashed boxes to indicate specific behavioral anchors corresponding to the behavioral anchor 122 used by the behavior identification 172 phase.

The system diagram shown in FIG. 6 may include multi-stage malware snapshots 604 represented as light blue squares with downward arrows that indicate temporal progression across execution stages. The multi-stage malware snapshots 604 may demonstrate how the memory extraction engine 114 captures memory regions at different points during malware execution to track the evolution of behavioral implementations. In some cases, a stage 1 memory snapshot 606 may be specifically marked with a red border to distinguish initial-stage memory captures from subsequent execution phases, enabling the temporal relationships 152 component to identify stage transitions in multi-stage malware execution.

With continued reference to FIG. 6, stage 1 gene 610 nodes may be visually distinguished by red borders to emphasize their role as initial-stage behavioral implementations. The stage 1 gene 610 nodes may represent genes that appear in the initial execution stages and may be associated with obfuscation tools or common third-party code rather than family-specific functionality. In some cases, the stage 1 gene 610 nodes may enable the computer-implemented method for detecting cross-family code sharing in malware to identify genes associated with obfuscation tools that appear only in initial execution stages, as specified in the temporal analysis approach.

As further shown in FIG. 6, at the top center of the diagram, a dashed box may be labeled create process with hidden window 612 and may connect to stage 1 gene 610 nodes from all three malware families via dashed lines. The create process with hidden window 612 behavior may represent a shared connection that illustrates cross-family code sharing at the initial execution stage, where all three malware families exhibit the same behavioral implementation. In some cases, this shared connection may demonstrate how the temporal analysis can identify specific obfuscation tools such as Nullsoft Scriptable Install System (NSIS) installers by detecting genes that only appear in initial execution stages across multiple malware families, enabling the malware analysis system 100 to distinguish between analogous genes representing shared obfuscation techniques and homologous genes representing family-specific behavioral implementations.

The temporal analysis illustrated in FIG. 6 may enable the computer-implemented method to distinguish between homologous genes and analogous genes through stage-based analysis of gene appearances across memory snapshots 602. Homologous genes may comprise genes shared by malware samples from the same family due to common ancestry, while analogous genes may comprise genes exhibiting the same behavior but originating from different malware families. In some cases, the analyzing of temporal relationships may comprise identifying stage transitions in multi-stage malware execution by detecting abandoned genes between consecutive memory snapshots 602, as demonstrated by the progression from stage 1 memory snapshot 606 to subsequent execution phases within each malware family section.

With continued reference to FIG. 6, the directional arrows connecting memory snapshots 602 may indicate the temporal sequence of snapshot captures, with arrows pointing from earlier snapshots to later snapshots in the execution timeline. The varying density and complexity of connections across the three malware family sections may reflect differences in execution patterns and behavioral richness among the malware families. In some cases, the spatial separation of the three malware families, combined with the shared stage 1 gene 610 connection through the create process with hidden window 612 behavior, may effectively demonstrate how temporal analysis of genes across memory snapshots can distinguish between homologous genes shared within a family due to common ancestry and analogous genes shared across families due to common tools or similar functionality.

The system diagram shown in FIG. 6 may demonstrate how the malware analysis system 100 may further comprise a temporal analysis module configured to analyze temporal relationships between memory snapshots to distinguish between homologous genes shared by malware samples from the same family and analogous genes exhibiting the same behavior but originating from different malware families. The temporal analysis module may leverage the patterns shown across the Locky 618, Flokibot 614, and Cerber 616 sections to identify both within-family behavioral evolution and cross-family code sharing patterns. In some cases, the temporal analysis module may enable the found browser password gene 138 component to classify genes based on their temporal appearance patterns, supporting the vet family label 158 task by providing evidence for distinguishing between legitimate family relationships and cross-family connections resulting from shared obfuscation tools.

As further shown in FIG. 6, the obfuscation tools may comprise Nullsoft Scriptable Install System (NSIS) installers used to deter malware analysis, as indicated by the stage 1 gene 610 connections to the create process with hidden window 612 behavior across all three malware families. The NSIS installers may appear as analogous genes in the initial execution stages, representing shared obfuscation techniques rather than family-specific behavioral implementations. In some cases, the temporal analysis may enable the malware analysis system 100 to identify these obfuscation patterns by detecting genes that appear consistently in stage 1 memory snapshot 606 captures across multiple malware families but are abandoned in subsequent execution stages, distinguishing them from homologous genes that persist throughout the execution timeline within individual malware families.

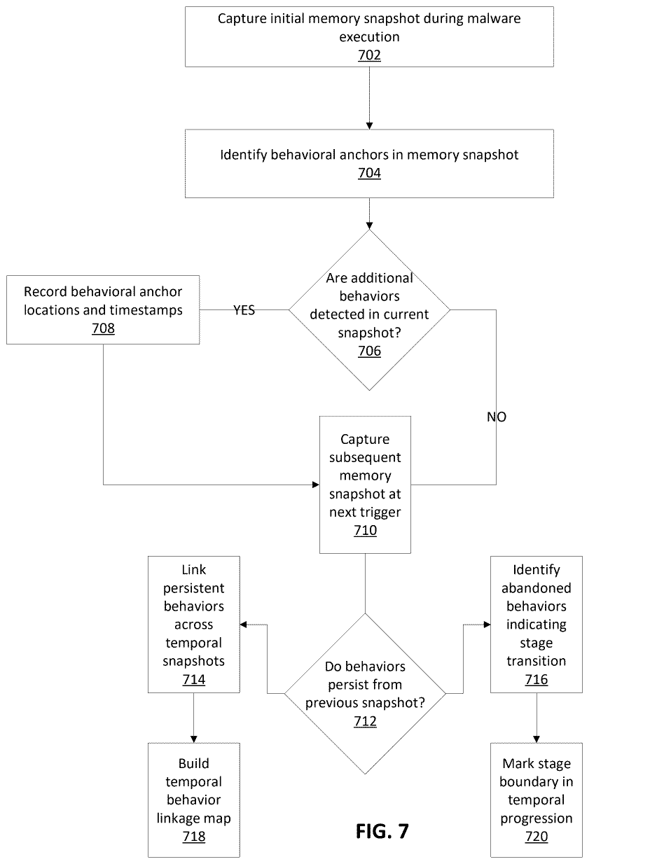

Referring to FIG. 7, a method 700 may provide a systematic approach for capturing and analyzing temporal behavioral patterns in malware execution through memory snapshots. The method 700 may be implemented by the malware analysis system 100 to track the evolution of malicious behaviors across multiple execution stages and identify temporal relationships between behavioral implementations. In some cases, the method 700 may enable the temporal relationships 152 component to distinguish between persistent behaviors that continue across execution stages and abandoned behaviors that signal transitions between malware execution phases.

As shown in FIG. 7, the method 700 may begin with a step 702 where an initial memory snapshot is captured during malware execution. The step 702 may correspond to the memory extraction 170 phase performed by the memory extraction engine 114, which may capture memory snapshots based on behavioral anchor triggers. In some cases, the step 702 may involve capturing memory regions when predetermined conditions are met, such as a memory region being made executable for a first time or detection of network behavior within code contained in a memory region.

With continued reference to FIG. 7, the method 700 may proceed to a step 704 where behavioral anchors are identified in the memory snapshot. The step 704 may correspond to the behavior identification 172 phase that employs the behavioral anchor 122 to locate specific implementations of behaviors within the captured memory snapshots. In some cases, the step 704 may involve using the found browser passwords 118 component to identify malicious behaviors through detection of application programming interface calls associated with malicious behaviors, such as CreateProcessA, WaitForSingleObject, and RegSetValueEx.

As further shown in FIG. 7, following the step 704, the method 700 may continue to a step 706 which presents a decision point to determine whether additional behaviors are detected in the current snapshot. The step 706 may enable the method 700 to assess whether the current memory snapshot contains multiple behavioral implementations that may require individual processing. In some cases, if additional behaviors are detected in the current snapshot, the method 700 may move to a step 708 where behavioral anchor locations and timestamps are recorded. If additional behaviors are not detected in the current snapshot, the method 700 may bypass the step 708 and proceed directly to a step 710.

The step 708 may involve recording the specific memory addresses and temporal information associated with each identified behavioral anchor. The step 708 may enable the temporal relationships 152 component to maintain a comprehensive record of when and where specific behavioral implementations appear during malware execution. In some cases, the step 708 may store behavioral anchor locations and timestamps in association with the gene datastore to support subsequent temporal analysis operations performed by the found browser password gene 138 component.

With continued reference to FIG. 7, from the step 708, the method 700 may continue to the step 710 where a subsequent memory snapshot is captured at the next trigger. The step 710 may involve the memory extraction engine 114 capturing additional memory regions based on subsequent trigger conditions that may indicate continued malware execution or behavioral evolution. In some cases, the step 710 may capture memory snapshots at predetermined intervals or when specific execution events occur, enabling the method 700 to track temporal progression of malicious behaviors across multiple execution stages.

As further shown in FIG. 7, following the step 710, the method 700 may proceed to a step 712, which presents another decision point that determines whether behaviors persist from the previous snapshot. The step 712 may enable the method 700 to identify whether behavioral implementations identified in earlier memory snapshots continue to be present in subsequent snapshots. In some cases, if behaviors persist from the previous snapshot, the method 700 may move to a step 714 where persistent behaviors are linked across temporal snapshots. If behaviors do not persist from the previous snapshot, the method 700 may proceed to a step 716 where abandoned behaviors indicating stage transition are identified.

The step 714 may involve creating temporal linkages between behavioral implementations that appear consistently across multiple memory snapshots. The step 714 may enable the temporal relationships 152 component to identify homologous genes that persist throughout malware execution within the same family. In some cases, the step 714 may support the found browser password gene 138 component in distinguishing between behavioral implementations that represent core family-specific functionality and those that may represent temporary or stage-specific operations.

With continued reference to FIG. 7, the step 716 may involve identifying behavioral implementations that were present in previous memory snapshots but are no longer detected in the current snapshot. The step 716 may enable the method 700 to detect stage transitions in multi-stage malware execution by identifying gene abandonment patterns. In some cases, the step 716 may correspond to the temporal analysis approach for detecting cross-family code sharing relationships, where abandoned behaviors may indicate transitions from dropper stages to payload stages in multi-stage malware execution.

As further shown in FIG. 7, following the step 714, the method 700 may continue to a step 718 where a temporal behavior linkage map is built. The step 718 may involve constructing a comprehensive representation of behavioral relationships across the temporal execution sequence. In some cases, the step 718 may create data structures that enable the find similar genes 154 component to analyze patterns of behavioral persistence and evolution within malware families, supporting the vet family label 158 task through temporal evidence of family-specific behavioral implementations.

Following the step 716, the method 700 may proceed to a step 720 where a stage boundary in temporal progression is marked. The step 720 may involve recording the specific temporal point where behavioral abandonment occurs, indicating a transition between execution stages. In some cases, the step 720 may enable the temporal relationships 152 component to identify dropper-payload relationships between different malware families by marking points where genes from one family are abandoned in favor of genes from another family, as demonstrated in the temporal analysis of Petrwrap Stage 1 506 transitioning to Petrwrap Stage 2 508.

The method 700 may provide terminal points in the step 718 and the step 720, representing the completion of temporal behavior linkage mapping and stage boundary identification respectively. The decision-making process implemented through the step 706 and the step 712 may enable the method 700 to systematically differentiate between persistent behaviors that continue across execution stages and abandoned behaviors that signal transitions between malware execution phases. In some cases, the method 700 may leverage temporal relationships to construct a comprehensive linkage map of behavioral implementations and identify stage boundaries that may indicate multi-stage malware execution or dropper-payload relationships, supporting the malware analysis system 100 in distinguishing between homologous genes shared within the same family due to common ancestry and analogous genes exhibiting similar functionality across different families.

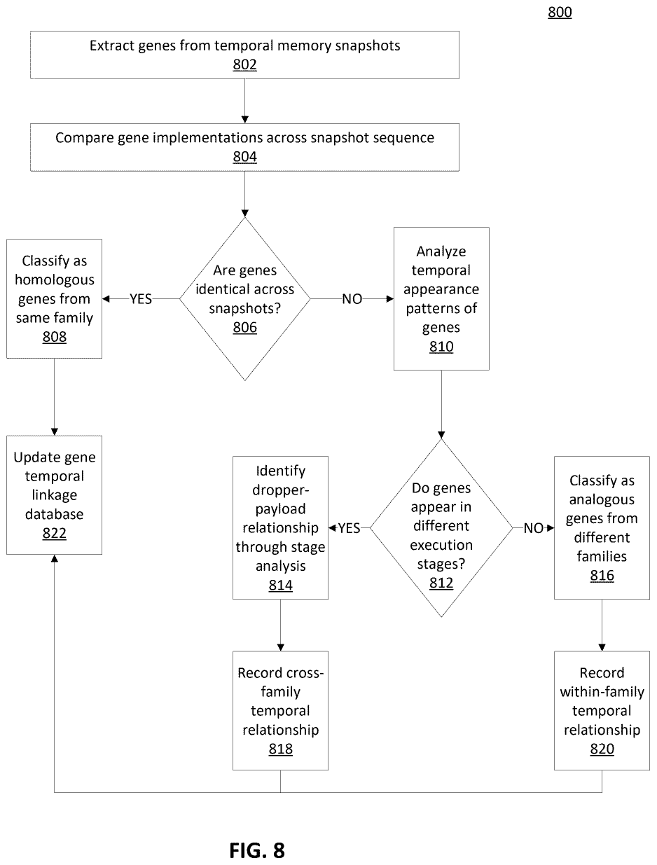

Referring to FIG. 8, a method 800 may provide a systematic approach for classifying genes and recording temporal relationships between malware families through analysis of temporal memory snapshots. The method 800 may be implemented by the malware analysis system 100 to distinguish between homologous genes shared by malware samples from the same family due to common ancestry and analogous genes exhibiting the same behavior but originating from different families. In some cases, the method 800 may enable the temporal relationships 152 component to analyze temporal appearance patterns of genes across execution stages and identify cross-family code sharing relationships through stage-based analysis.

As shown in FIG. 8, the method 800 may begin with a step 802 where genes are extracted from temporal memory snapshots. The step 802 may correspond to the gene extraction 174 phase performed by the behavior anchor 132 component using the 134 approach. In some cases, the step 802 may involve extracting assembly-level code implementations from memory snapshots captured during dynamic execution, where each assembly-level code implementation may represent a gene corresponding to an implementation of a malicious behavior identified through the behavioral anchor 122.

With continued reference to FIG. 8, the method 800 may proceed to a step 804 where gene implementations are compared across the snapshot sequence. The step 804 may involve analyzing the temporal progression of behavioral implementations to identify patterns of gene persistence, evolution, or abandonment across multiple memory snapshots captured during malware execution. In some cases, the step 804 may enable the found browser password gene 138 component to track how specific behavioral implementations change or remain consistent across different execution stages, providing temporal context for subsequent gene classification operations.

As further shown in FIG. 8, following the step 804, the method 800 may continue to a step 806 which presents a decision point to determine whether genes are identical across snapshots. The step 806 may enable the method 800 to identify behavioral implementations that remain consistent throughout the temporal execution sequence. In some cases, if genes are identical across snapshots, the method 800 may move to a step 808 where the genes are classified as homologous genes from the same family. If genes are not identical across snapshots, the method 800 may proceed to a step 810 where temporal appearance patterns of genes are analyzed.

The step 808 may involve classifying genes that exhibit identical assembly-level implementations across temporal memory snapshots as homologous genes representing shared ancestry within the same malware family. The step 808 may enable the temporal relationships 152 component to identify behavioral implementations that persist consistently throughout malware execution, indicating core family-specific functionality. In some cases, following the step 808, the method 800 may continue to a step 822 where a gene temporal linkage database is updated with the homologous gene classification and associated temporal relationship data.

With continued reference to FIG. 8, the step 810 may involve analyzing temporal appearance patterns of genes that are not identical across snapshots to determine the nature of their temporal relationships. The step 810 may enable the method 800 to examine when specific genes appear and disappear during malware execution, providing insights into multi-stage execution patterns or cross-family code sharing relationships. In some cases, the step 810 may analyze the timing and sequence of gene appearances to distinguish between within-family behavioral evolution and cross-family code sharing patterns.

As further shown in FIG. 8, the method 800 may then continue to a step 812, which presents another decision point that determines whether genes appear in different execution stages. The step 812 may enable the method 800 to identify temporal patterns that may indicate multi-stage malware execution or dropper-payload relationships between different malware families. In some cases, if genes appear in different execution stages, the method 800 may move to a step 814 where a dropper-payload relationship is identified through stage analysis. If genes do not appear in different execution stages, the method 800 may proceed to a step 816 where the genes are classified as analogous genes from different families.

The step 814 may involve identifying dropper-payload relationships where genes from one malware family are abandoned in favor of genes from another malware family during stage transitions. The step 814 may enable the method 800 to detect cross-family code sharing patterns that result from multi-stage malware execution, where a dropper from one family loads and executes a payload from a different family. In some cases, the step 814 may correspond to the temporal analysis demonstrated in the sequence diagram, where genes from the Petrwrap Stage 1 506 are abandoned during the transition to the Petrwrap Stage 2 508, while new genes appear that correspond to genes found in the Petya 516.

With continued reference to FIG. 8, following the step 814, the method 800 may proceed to a step 818 where a cross-family temporal relationship is recorded. The step 818 may involve documenting the temporal patterns and stage transitions that indicate code sharing between different malware families. In some cases, the step 818 may record specific details about the timing of gene abandonment and appearance patterns that provide evidence for dropper-payload relationships or other forms of cross-family code sharing.

As further shown in FIG. 8, the step 816 may involve classifying genes as analogous genes from different families when temporal analysis indicates that the genes exhibit the same behavior but originate from different malware families without stage-based transitions. The step 816 may enable the method 800 to identify behavioral implementations that represent similar functionality across different families but do not indicate dropper-payload relationships. In some cases, the step 816 may classify genes that appear consistently within their respective families but share similar behavioral implementations across family boundaries, such as common obfuscation techniques or shared development tools.

Following the step 816, the method 800 may continue to a step 820 where a within-family temporal relationship is recorded. The step 820 may involve documenting temporal patterns that indicate behavioral evolution or variation within individual malware families. In some cases, the step 820 may record information about how behavioral implementations change over time within the same family, supporting the vet family label 158 task by providing evidence for legitimate family relationships based on temporal behavioral patterns.

As further shown in FIG. 8, the step 822 may represent a terminal point where the gene temporal linkage database is updated with classification results and temporal relationship data. The step 822 may involve storing the results of gene classification operations along with associated temporal metadata in the gene datastore for subsequent analysis operations. In some cases, the step 822 may update the database with homologous gene classifications from the step 808, cross-family temporal relationships from the step 818, and within-family temporal relationships from the step 820.

The method 800 may provide a systematic approach for distinguishing between homologous genes, which may be shared by malware from the same family due to common ancestry, and analogous genes, which may exhibit the same behavior but originate from different families. The decision-making process implemented through the step 806 and the step 812 may enable the method 800 to differentiate between genes that remain consistent across temporal snapshots and genes that exhibit temporal variation patterns. In some cases, the method 800 may leverage temporal analysis to identify dropper-payload relationships where genes transition between execution stages, and may maintain separate records of cross-family and within-family temporal relationships in the gene temporal linkage database.

Table 9 may present evidence of mislabeling issues discovered during cross-family relationship analysis, showing malware samples from an OSINT report with their assigned family labels and corresponding shared gene evidence. The table may include columns for OSINT Report Family labels and True Family classifications, along with the number of shared genes (n) and whether those genes are unique to the correct family. The table may demonstrate cases where samples labeled as one family in OSINT reports actually share genes exclusively with samples from a different family, indicating systematic labeling errors. In some cases, the table may show that samples from row 1 labeled as “H1N1Loader” actually share 5 unique genes with samples from the “Cryptowall” family, while samples from row 3 labeled as “Pony” share 11 unique genes with samples from the “Neutrinobot” family.

TABLE 9
Table of malware samples from on OSINT report, n is the
number of genes shared between the malware in the report
and other samples in the true family. The ÷ symbol
indicates whether those genes are unique to the correct
family. The samples from row 0 and row 2 are not included
in MOTIF and no genes were recovered for sample in row 5.

| | OSINT | Shared Genes | | |
|---|---|---|---|---|
| | Family | Family | n | ÷ |
| 0 | CryptoWall | — | — | — |
| 1 | HINILoader | CryptoWall | 5 | ✓ |
| 2 | Neutrinobot | — | — | — |
| 3 | Pony | Neutrinobot | 11 | ✓ |
| 4 | TinyLoader | Pony | 1 | ✓ |
| 5 | SmokeLoader | — | — | — |
| 6 | TVSpy | SmokeLoader | 3 | ✓ |
| 7 | Dridex | Retefe | 2 | X |
| 8 | Ursnif | Dridex | 22 | ✓ |

The mislabeling patterns revealed in Table 9 may provide concrete evidence that motivated the development of the automated label rectification approach described in Algorithm 2. The discovery that multiple samples exhibited strong gene-based connections to families different from their assigned labels may indicate systematic errors in the ground truth dataset, where samples may have been incorrectly categorized due to off-by-one errors in report layouts or other documentation mistakes. In some cases, the high number of unique genes shared between mislabeled samples and their correct families, combined with the absence of shared genes with their originally assigned families, may demonstrate that gene-based analysis can identify and correct labeling errors that would otherwise propagate through malware family classification systems and reduce the accuracy of automated analysis tools.

As further shown in FIG. 8, the step 822 may represent a terminal point where the gene temporal linkage database is updated with classification results and temporal relationship data. The step 822 may involve storing the results of gene classification operations along with associated temporal metadata in the gene datastore for subsequent analysis operations. In some cases, the step 822 may update the database with homologous gene classifications from the step 808, cross-family temporal relationships from the step 818, and within-family temporal relationships from the step 820.

The method 800 may provide a systematic approach for distinguishing between homologous genes, which may be shared by malware from the same family due to common ancestry, and analogous genes, which may exhibit the same behavior but originate from different families. The decision-making process implemented through the step 806 and the step 812 may enable the method 800 to differentiate between genes that remain consistent across temporal snapshots and genes that exhibit temporal variation patterns. In some cases, the method 800 may leverage temporal analysis to identify dropper-payload relationships where genes transition between execution stages, and may maintain separate records of cross-family and within-family temporal relationships in the gene temporal linkage database.

With continued reference to FIG. 8, the method 800 may enable the malware analysis system 100 to classify cross-family code sharing relationships based on temporal relationships, wherein genes appearing in different execution stages may indicate dropper-payload relationships between different malware families. The temporal analysis performed through the step 810 and the step 814 may correspond to the computer-implemented method for detecting cross-family code sharing in malware, where analyzing temporal relationships may comprise identifying stage transitions in multi-stage malware execution by detecting abandoned genes between consecutive memory snapshots. In some cases, the method 800 may support the find similar genes 154 component by providing classified gene relationships that enable accurate malware family identification while distinguishing between legitimate family connections and cross-family code sharing patterns.

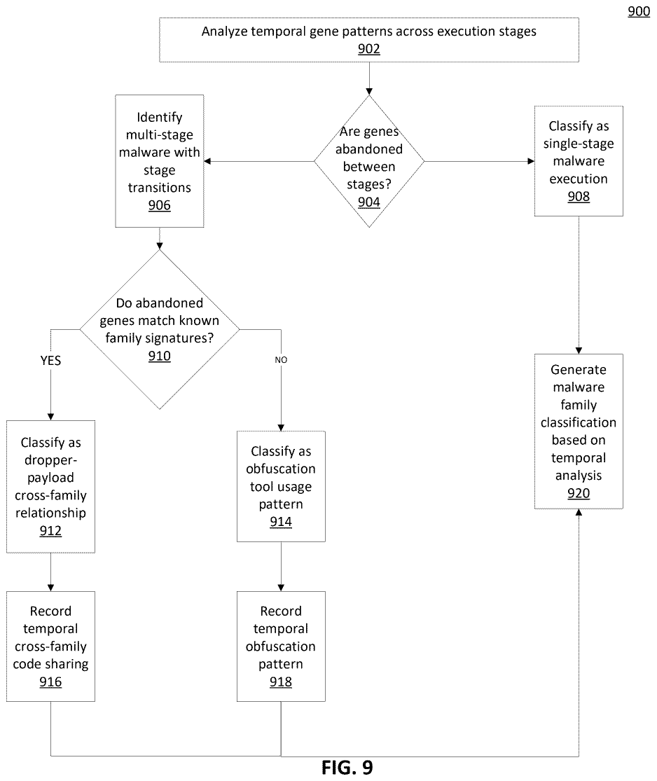

Referring to FIG. 9, a method 900 may provide a systematic approach for analyzing temporal gene patterns and classifying malware execution stages to distinguish between single-stage and multi-stage malware execution patterns. The method 900 may be implemented by the malware analysis system 100 to identify dropper-payload relationships and obfuscation tool usage patterns through temporal analysis of gene abandonment across execution stages. In some cases, the method 900 may enable the temporal relationships 152 component to classify cross-family code sharing relationships and generate accurate malware family classifications based on temporal behavioral patterns.

As shown in FIG. 9, the method 900 may begin with a step 902 where temporal gene patterns are analyzed across execution stages. The step 902 may involve examining the temporal progression of behavioral implementations captured through multiple memory snapshots during malware execution. In some cases, the step 902 may correspond to the gene extraction 174 phase where assembly-level implementations are tracked across different execution phases to identify patterns of gene persistence, evolution, or abandonment that may indicate multi-stage malware execution or cross-family code sharing relationships.

With continued reference to FIG. 9, the method 900 may proceed to a step 904 which presents a decision point to determine whether genes are abandoned between stages. The step 904 may enable the method 900 to identify temporal patterns where behavioral implementations present in earlier execution stages are no longer detected in subsequent stages. In some cases, the step 904 may analyze memory snapshots captured by the memory extraction engine 114 to detect gene abandonment patterns that may signal transitions between different execution phases or indicate the presence of multi-stage malware execution.

As further shown in FIG. 9, if genes are abandoned between stages, the method 900 may move to a step 906 where multi-stage malware with stage transitions is identified. The step 906 may involve classifying the malware execution as exhibiting multi-stage behavior based on the detection of gene abandonment patterns. In some cases, the step 906 may enable the temporal relationships 152 component to identify malware samples that transition between different execution phases, potentially indicating dropper-payload relationships or staged deployment of malicious functionality.

If genes are not abandoned between stages, the method 900 may proceed to a step 908 where the execution is classified as single-stage malware execution. The step 908 may involve determining that the malware exhibits consistent behavioral implementations throughout the execution timeline without significant stage transitions. In some cases, the step 908 may classify malware samples that maintain persistent gene expressions across temporal memory snapshots, indicating unified execution patterns without dropper-payload relationships or staged behavioral deployment.

With continued reference to FIG. 9, from the step 906, the method 900 may continue to a step 910, which presents another decision point that determines whether abandoned genes match known family signatures. The step 910 may enable the method 900 to analyze whether genes that are abandoned during stage transitions correspond to behavioral implementations associated with specific malware families stored in the gene datastore. In some cases, the step 910 may compare abandoned genes against previously indexed implementations to determine whether the stage transition represents a cross-family relationship or an obfuscation tool usage pattern.

As further shown in FIG. 9, if abandoned genes match known family signatures, the method 900 may move to a step 912 where a dropper-payload cross-family relationship is classified. The step 912 may involve identifying relationships where genes from one malware family are abandoned in favor of genes from a different malware family during stage transitions. In some cases, the step 912 may correspond to the temporal analysis demonstrated in the sequence diagram, where genes from the Petrwrap Stage 1 506 are abandoned during the transition to the Petrwrap Stage 2 508, while new genes appear that match genes from the Petya 516, indicating a dropper-payload relationship between different malware families.

If abandoned genes do not match known family signatures, the method 900 may proceed to a step 914 where an obfuscation tool usage pattern is classified. The step 914 may involve identifying genes that are abandoned during stage transitions but do not correspond to specific malware family signatures, indicating the use of third-party obfuscation tools or common development frameworks. In some cases, the step 914 may identify patterns where genes associated with obfuscation tools appear only in initial execution stages, such as the create process with hidden window 612 behavior that may be associated with Nullsoft Scriptable Install System (NSIS) installers used across multiple malware families.

With continued reference to FIG. 9, following the step 912, the method 900 may continue to a step 916 where temporal cross-family code sharing is recorded. The step 916 may involve documenting the temporal patterns and stage transitions that provide evidence for dropper-payload relationships between different malware families. In some cases, the step 916 may record specific details about the timing of gene abandonment and the appearance of genes from different families, supporting the vet family label 158 task by providing concrete evidence for cross-family connections that may be used to validate claims made in threat intelligence reports.

As further shown in FIG. 9, following the step 914, the method 900 may proceed to a step 918 where a temporal obfuscation pattern is recorded. The step 918 may involve documenting the temporal patterns associated with obfuscation tool usage, including the specific stages where obfuscation-related genes appear and are subsequently abandoned. In some cases, the step 918 may record information about common obfuscation techniques that appear consistently across multiple malware families in initial execution stages, enabling the found browser password gene 138 component to distinguish between obfuscation-related analogous genes and family-specific homologous genes.

From the step 908, the method 900 may proceed to a step 920 where a malware family classification is generated based on temporal analysis. The step 920 may involve producing family classification results for single-stage malware execution based on the consistent behavioral implementations observed throughout the execution timeline. In some cases, the step 920 may generate classifications that support the find similar genes 154 component in identifying malware family relationships through persistent gene expressions that indicate homologous genes shared within the same family due to common ancestry.

As further shown in FIG. 9, the step 916, the step 918, and the step 920 may represent terminal points in their respective branches of the method 900, indicating the completion of temporal analysis and classification operations. The decision-making process implemented through the step 904 and the step 910 may enable the method 900 to systematically differentiate between dropper-payload relationships, where genes from one family are abandoned in favor of genes from another family, and obfuscation tool usage patterns, where genes associated with third-party obfuscation tools appear only in initial execution stages.

With continued reference to FIG. 9, the method 900 may leverage temporal relationships to identify cross-family code sharing and may record both temporal cross-family relationships and temporal obfuscation patterns, facilitating accurate malware family classification and detection of code reuse patterns across different malware families. The method 900 may enable the malware analysis system 100 to distinguish between legitimate within-family code evolution and cross-family code sharing patterns that may result from multi-stage malware execution or shared obfuscation techniques. In some cases, the method 900 may support the malware analyst 102 in understanding complex malware execution patterns and may provide evidence-based classifications that enhance the accuracy of malware family identification through temporal behavioral analysis.

The method 900 may provide a comprehensive approach for analyzing temporal gene patterns that enables the temporal relationships 152 component to classify different types of malware execution patterns and code sharing relationships. The systematic analysis of gene abandonment patterns through the step 904 and the step 910 may enable accurate identification of multi-stage malware execution, dropper-payload relationships, and obfuscation tool usage patterns. In some cases, the method 900 may enhance the effectiveness of the found browser password gene 138 component by providing temporal context for gene classifications, supporting more accurate malware family identification while distinguishing between homologous genes representing family-specific functionality and analogous genes representing shared obfuscation techniques or cross-family code sharing patterns.

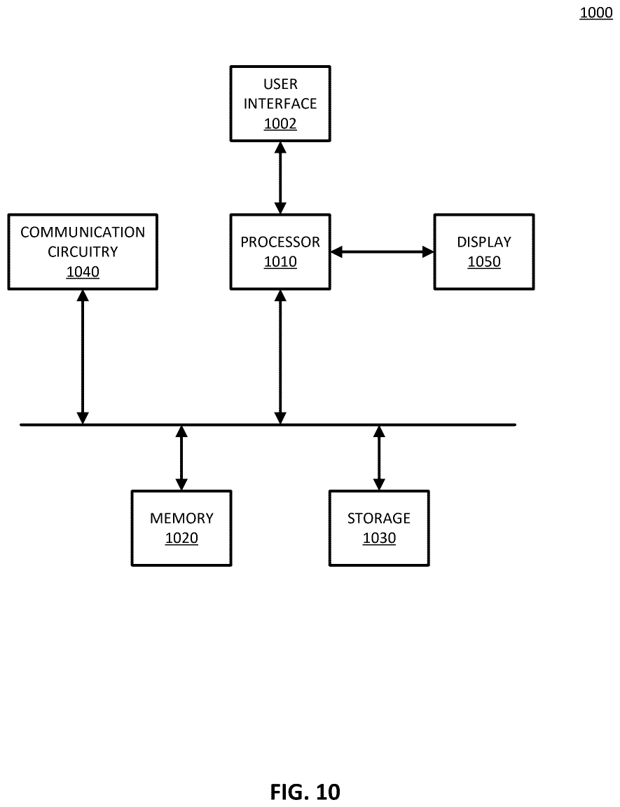

Referring to FIG. 10, a computing system architecture may be illustrated that provides the hardware foundation for implementing the malware analysis system 100. The computing system may comprise a processor 1010 that serves as the central processing unit for coordinating all system operations and data processing tasks. In some cases, the processor 1010 may be configured to execute the various software components and algorithms described throughout the disclosure, including the memory extraction engine 114, behavior anchor 132 component, and found browser password gene 138 component.

The computing system may include a user interface 1002 that enables interaction between the malware analyst 102 and the malware analysis system 100. The user interface 1002 may be connected to the processor 1010 through bidirectional communication pathways that allow for input commands and system responses. In some cases, the user interface 1002 may provide access to the various analytical tasks including the validate OSINT report 156 and vet family label 158 functions, enabling the malware analyst 102 to interact with the find similar genes 154 component and review temporal relationships 152 analysis results.

A display 1050 may be positioned to provide visual output presentation of analysis results and system status information. The display 1050 may be connected to the processor 1010 to present graphical representations of the malware similarity network 400, temporal analysis results from the sequence diagrams, and statistical distributions such as those shown in the density distribution 202 histograms. In some cases, the display 1050 may render visualizations of gene nodes 414, malware sample nodes 416, and the various relationships between behavioral implementations across different malware families.

Communication circuitry 1040 may be connected to the processor 1010 to facilitate network connectivity and external data communication capabilities. The communication circuitry 1040 may enable the system to receive malicious executable 104 samples from external sources such as MOTIF 106, VX Underground 108, and Malshare 110 through the malware aggregation 112 component. In some cases, the communication circuitry 1040 may support real-time data exchange with threat intelligence feeds and enable collaborative analysis workflows between multiple malware analysts.

The computing system may include memory 1020 and storage 1030 components that are connected to the processor 1010 through a common communication pathway. The memory 1020 may provide high-speed temporary storage for active processing operations, while the storage 1030 may offer persistent data retention capabilities. In some cases, both memory 1020 and storage 1030 may work in conjunction to support the various data-intensive operations performed by the malware analysis system 100.

In the context of the present invention, the processor 1010 may execute the 134 algorithms that process memory snapshots 116 captured during dynamic malware execution. The processor 1010 may coordinate the behavior identification 172 phase by running pattern matching algorithms against the signatures 126 stored in memory 1020 or storage 1030. In some cases, the processor 1010 may perform the computationally intensive delayed execution by sleep gene 140 comparisons between extracted genes and previously indexed implementations stored across multiple gene datastore instances.

The memory 1020 may serve as temporary storage for the plurality of memory snapshots 116 captured by the memory extraction engine 114 during dynamic execution of malicious executables. The memory 1020 may hold intermediate processing results from the behavior anchor 132 component, including assembly-level code implementations that represent genes corresponding to implementations of malicious behaviors. In some cases, the memory 1020 may cache frequently accessed behavioral anchor 122 and maintain active datasets during the gene matching 176 phase to optimize processing performance.

The storage 1030 may provide persistent storage for the gene datastore, gene datastore, gene datastore 146, gene datastore 147, and gene datastore 148 that contain previously indexed behavioral implementations. The storage 1030 may maintain historical records of temporal relationships 152 analysis results, including classifications of homologous genes and analogous genes across different malware families. In some cases, the storage 1030 may store the comprehensive datasets used for malware family classification, including the matching genes 150 identified through similarity analysis and the temporal cross-family relationships recorded through methods 800 and 900.

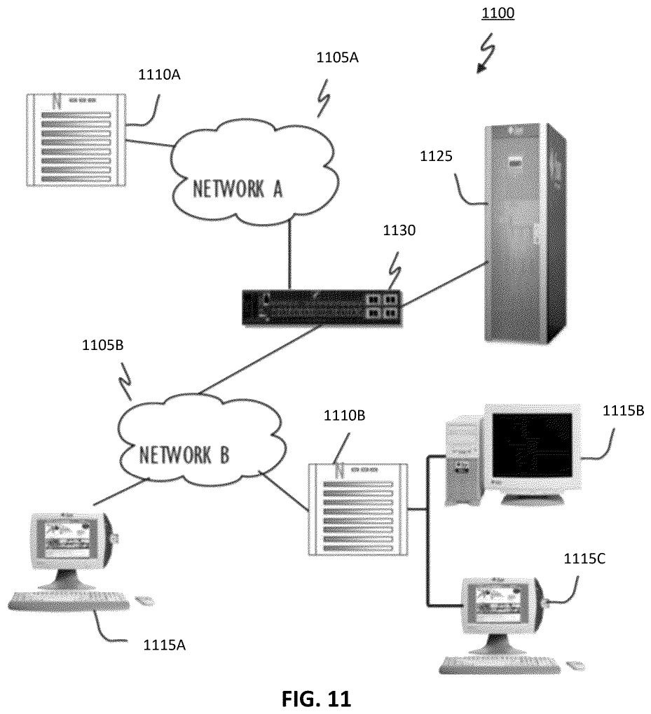

Referring to FIG. 11, a network architecture diagram may illustrate a distributed computing environment that enables the malware analysis system 100 to operate across multiple networked devices and data sources. The network architecture may comprise a first network connection 1105A and a second network connection 1105B that facilitate communication between various system components distributed across the network infrastructure. In some cases, the network connections may support the communication circuitry 1040 described in FIG. 10 by providing the underlying network pathways for data exchange between the processor 1010 and external malware sample sources.

The distributed architecture may include a first malware sample source 1110A and a second malware sample source 1110B that correspond to the external data sources such as MOTIF 106, VX Underground 108, and Malshare 110 referenced in the malware aggregation 112 component. These malware sample sources may provide the malicious executable 104 samples that are processed by the memory extraction engine 114 during dynamic execution analysis. In some cases, the malware sample sources may be geographically distributed to provide redundancy and load balancing capabilities for the large-scale malware analysis operations described throughout the disclosure.

The network architecture may support multiple client devices including a first client device 1115A, a second client device 1115B, and a third client device 1115C that enable distributed access to the malware analysis system 100 functionality. These client devices may provide the user interface 1002 capabilities described in FIG. 10, allowing multiple malware analysts 102 to simultaneously interact with the find similar genes 154 component and perform tasks such as validate OSINT report 156 and vet family label 158 operations. In some cases, the distributed client architecture may enable collaborative analysis workflows where multiple analysts can review temporal relationships 152 analysis results and share insights about malware family classifications across different geographic locations.

A central server 1125 may coordinate the distributed processing operations and may house the core components of the malware analysis system 100, including the behavior anchor 132 component, found browser password gene 138 component, and the multiple gene datastore instances. The server 1125 may implement the processor 1010, memory 1020, and storage 1030 components described in FIG. 10 at an enterprise scale to support the computationally intensive operations required for 134 and delayed execution by sleep gene 140 comparisons across large datasets. In some cases, the server 1125 may distribute processing tasks across multiple nodes to handle the substantial computational overhead associated with analyzing memory snapshots 116 and performing temporal relationships 152 analysis for thousands of malware samples simultaneously.

A network switch 1130 may facilitate communication routing between the various network components and may ensure reliable data transmission for the time-sensitive malware analysis workflows. The network switch 1130 may support the real-time data exchange capabilities enabled by the communication circuitry 1040, allowing the system to rapidly process new malicious executable 104 samples as they become available from the malware sample sources. In some cases, the distributed network architecture may enable the malware analysis system 100 to scale horizontally by adding additional client devices, malware sample sources, and processing nodes to accommodate growing analysis demands while maintaining the performance improvements achieved through the 134 approach and efficient gene matching 176 operations.

The network architecture may be implemented using a plurality of networks 1105, including the first network connection 1105A and the second network connection 1105B, each of which may take any form including, but not limited to, a local area network (LAN) or a wide area network (WAN) such as the Internet. The networks 1105 may use any desired technology, including wired, wireless, or a combination thereof, to facilitate data transmission between the various components of the malware analysis system 100. In some cases, the networks 1105 may employ various communication protocols such as TCP (transmission control protocol) or PPP (point to point protocol) to ensure reliable data exchange between the distributed system components. The flexible network configuration may enable the malware analysis system 100 to adapt to different deployment environments and may support both local and remote analysis operations while maintaining consistent performance across the behavior anchor 132, found browser password gene 138, and temporal relationships 152 analysis components.

The client or end-user computer systems 1115 may take the form of any computational device including, but not limited to, the electronic device components shown in FIG. 10, tablet computer systems, desktop or notebook computer systems, virtual-reality or intelligent machines including embedded systems. The client computer systems 1115 may provide flexible access points for malware analysts 102 to interact with the malware analysis system 100 through various device form factors and computing platforms. In some cases, the diverse range of supported client devices may enable analysts to perform malware family classification tasks and review temporal relationships 152 analysis results from different locations and using different computing environments, supporting both field analysis operations and centralized laboratory workflows.

The network architecture may also include network printers and network storage systems such as the server 1125 to facilitate communication between different network devices, including the server computer systems, client computer systems 1115, network printers, and storage systems. The storage system 1125 may be used to store multi-media items or links to other input, output, or intermediate processing-, storage-, backup- or recovery-related data referenced throughout the malware analysis operations. In some cases, the data stored may include application software, configuration, and licensing information; application instance and configuration information; analyst configuration and preferences; user, client, and project information, libraries and templates; computational models and ratings; archival storage and backup/recovery information; system resiliency and redundancy information; storage and networking sources and data whether standalone, local, remote, or cloud networked; and metadata and meta-metadata about the aforementioned information. The comprehensive data storage capabilities may support the gene datastore instances and temporal relationships 152 analysis by providing scalable storage infrastructure for the large volumes of behavioral implementation data and malware family classification results generated by the malware analysis system 100.

A number of implementations have been described. Nevertheless, it will be understood that various modifications may be made without departing from the spirit and scope of the disclosure. Accordingly, other implementations are within the scope of the following claims.

1. A computer-implemented method for identifying malware family relationships, comprising:
capturing a plurality of memory snapshots of a malicious executable during dynamic execution, wherein each memory snapshot is triggered by detection of a behavioral anchor corresponding to a malicious behavior;
extracting assembly-level code implementations from the memory snapshots using targeted disassembly, wherein each assembly-level code implementation represents a gene corresponding to an implementation of the malicious behavior;
comparing the genes extracted from a first malware sample with genes stored in a gene datastore to identify similar genes; and
determining a malware family relationship between the first malware sample and a second malware sample based on shared genes that exhibit similar malicious behavior, and the similar malicious behavior is determined using binary code similarity metrics.

2. The computer-implemented method of claim 1, wherein the behavioral anchor comprises an application programming interface (API) call associated with the malicious behavior.

3. The computer-implemented method of claim 2, wherein the API call comprises one or more application programming interface calls associated with malicious behaviors.

4. The computer-implemented method of claim 1, wherein the targeted disassembly comprises:
starting disassembly at an address of the behavioral anchor;
applying recursive descent disassembly to identify instructions following the behavioral anchor;
identifying a closest API call site prior to the behavioral anchor; and
disassembling code between the closest API call site and the behavioral anchor.

5. The computer-implemented method of claim 4, wherein the targeted disassembly further comprises applying linear sweep disassembly to identify adjacent functions when recursive descent disassembly fails to cross function boundaries.

6. The computer-implemented method of claim 1, wherein capturing the plurality of memory snapshots comprises using a plurality of snapshot triggers, each snapshot trigger configured to capture memory regions when predetermined conditions are met.

7. The computer-implemented method of claim 6, wherein the predetermined conditions comprise:
a memory region being made executable for a first time;
detection of network behavior within code contained in a memory region; and
termination of a process associated with the malicious executable.

8. The computer-implemented method of claim 1, further comprising analyzing temporal relationships between the memory snapshots to distinguish between homologous genes and analogous genes.

9. The computer-implemented method of claim 8, wherein homologous genes comprise genes shared by malware samples from the same family due to common ancestry, and analogous genes comprise genes exhibiting the same behavior but originating from different malware families.

10. The computer-implemented method of claim 9, wherein analyzing temporal relationships comprises identifying stage transitions in multi-stage malware execution by detecting abandoned genes between consecutive memory snapshots.

11. A malware analysis system, comprising:
a memory extraction engine configured to capture memory snapshots of malicious executables during dynamic execution based on behavioral anchor triggers;
a gene extraction module configured to extract assembly-level behavioral implementations from the memory snapshots using targeted disassembly;
a gene datastore configured to store the extracted assembly-level behavioral implementations; and
a gene matching module configured to compare genes between malware samples and identify malware family relationships based on shared assembly-level implementations of malicious behaviors.

12. The malware analysis system of claim 11, wherein the behavioral anchor triggers comprise detection of application programming interface calls associated with malicious behaviors.

13. The malware analysis system of claim 12, wherein the application programming interface calls comprise one or more calls associated with malicious behaviors.

14. The malware analysis system of claim 11, wherein the targeted disassembly comprises:
starting disassembly at an address of a behavioral anchor;
applying recursive descent disassembly to identify instructions following the behavioral anchor;
identifying a closest API call site prior to the behavioral anchor; and
disassembling code between the closest API call site and the behavioral anchor.

15. The malware analysis system of claim 11, further comprising a temporal analysis module configured to analyze temporal relationships between memory snapshots to distinguish between homologous genes shared by malware samples from the same family and analogous genes exhibiting the same behavior but originating from different malware families.

16. A computer-implemented method for detecting cross-family code sharing in malware, comprising:
capturing temporal memory snapshots of a malicious executable across multiple execution stages;
extracting genes representing assembly-level implementations of malicious behaviors from each temporal memory snapshot;
analyzing temporal relationships between the genes across the execution stages to identify gene abandonment patterns; and
classifying cross-family code sharing relationships based on the temporal relationships, wherein genes appearing in different execution stages indicate dropper-payload relationships between different malware families.

17. The computer-implemented method of claim 16, wherein analyzing temporal relationships comprises identifying a stage transition when genes present in a first execution stage are abandoned in a subsequent execution stage.

18. The computer-implemented method of claim 17, wherein classifying cross-family code sharing relationships comprises determining that genes appearing in the subsequent execution stage match genes from a different malware family than genes appearing in the first execution stage.

19. The computer-implemented method of claim 16, wherein the genes appearing in different execution stages comprise genes associated with obfuscation tools that appear only in initial execution stages.

20. The computer-implemented method of claim 19, wherein the obfuscation tools comprise obfuscation software exhibiting behaviors in initial execution stages configured to deter malware analysis.
